(19) United States
(12) Patent Application Publication
(10) Pub. No.: US 2012/0194457 A1
(43) Pub. Date: Aug. 2, 2012

(54) Identifiable Object and a System for Identifying an Object by an Electronic Device

(76) Inventors: Bruce Cannon, El Segundo, CA (US); Kevin Kai Cao, Reseda, CA (US)

(21) Appl. No.: 13/360,761

(22) Filed: Jan. 29, 2012

Related U.S. Application Data
(60) Provisional application No. 61/437,118, filed on Jan. 28, 2011.
(60) Provisional application No. 61/442,086, filed on Feb. 11, 2011.

(51) Int. Cl. G06F 3/033; G06F 3/041

(52) U.S. Cl. 345/173; 345/179

(57) ABSTRACT

An object is identifiable by an electronic device having a touch screen. The object includes contact members that can engage or be positioned proximate to the touch screen. The contact members create contact points that are sensed or detected by the touch screen. The object is at least partly conductive and includes at least a first contact member and a second contact member spaced from the first contact member. The first and second contact members define the pattern of contact points. An output is generated and displayed by the touch screen when the object engages or is proximate to the touch screen and is identified.

### CROSS-REFERENCE TO RELATED APPLICATIONS

This application claims priority to and the benefit of U.S. Provisional Patent Application No. 61/437,118, filed Jan. 28, 2011, Attorney Docket No. 1389.0306P/16901P, entitled “Identifiable Object and a System for Identifying an Object by an Electronic Device,” and U.S. Provisional Patent Application No. 61/442,086, filed Feb. 11, 2011, Attorney Docket No. 1389.0306P1/16901P1, entitled “Identifiable Object and a System for Identifying an Object by an Electronic Device,” the contents of each of which is hereby incorporated by reference in full.

### FIELD OF THE INVENTION

The present invention relates to a system for identifying an object, such as a toy figure or toy vehicle, on a touch screen of an electronic device. The present invention also relates to an object that is identifiable by an electronic device.

### BACKGROUND OF THE INVENTION

Various electronic devices including a touch screen configured to detect an object (e.g. a stylus) or a user's finger are known. Some electronic devices provide for a virtual environment presented on a display, on which physical objects may be placed on the display and optically detected using a camera. Other devices receive data transmitted from memory provided in an object. Such conventional devices are relatively complex and/or fail to recognize the identity, location and/or orientation of an object on a touch screen of an electronic device.

### SUMMARY OF THE INVENTION

The present invention is directed to a system for identifying an object. The system includes an electronic device having a touch screen, and an object recognizable by the touch screen. The object may be a toy figure, a toy vehicle, a toy building, a playing card, a geometric structure, etc. The object includes a first contact member engageable with the touch screen and a second contact member engageable with the touch screen. The first contact member is spaced from the second contact member by a first distance. The electronic device identifies the conductive object when the first and second contact members engage the touch screen. In addition, the system can be used to detect a gesture or movement of an object.

The first and second contact members define a pattern of contact points on the touch screen recognizable by the electronic device for identifying the object. The location and/or orientation of the object on the touch screen may also be determined based on the pattern of contact points on the touch screen.

In one embodiment, the object is a first conductive object. The system includes a second object having a third contact member engageable with the touch screen and a fourth contact member engageable with the touch screen. The third contact member is spaced from the fourth contact member by a second distance. The second distance differs from the first distance. The electronic device identifies the second object when the third and fourth contact members engage the touch screen.

In one embodiment, the object includes a conductive coating that conducts a user's capacitance to the touch screen for actuation thereof. The object may include a plastic core substantially coated by a conductive material. Alternatively, the object may be a metal object, a conductive rubber object, a plain rubber object with conductive rubber coating, or a co-molded object having some conductive regions. The object may be either hard or soft.

The present invention also relates to a system that enables a toy to interact with an electronic device. The electronic device, external to the toy, has a touch screen and is configured to generate some sort of state change in the device, such as an output on the touch screen, when a pattern of contact points is sensed by the touch screen. One type of state change can be internal (such as incrementing a count, or changing an internal system state). Another type of state change can be external (such as generating a visible output on the screen or other device, or generating a different output, including a signal transmission, an internet update, sounds, or lights). A conductive object includes at least a first contact member and a second contact member spaced from the first contact member. The first and second contact members define the pattern of contact points. The output is generated and displayed by the touch screen when the object engages the touch screen.

In one implementation, the conductive object includes a third contact member. The first, second and third contact members define the pattern of contact points. In alternative embodiments, the conductive object may include any number of contact members. The quantity of contact members on a conductive object may be limited by the quantity of simultaneous touches that can be detected by an electronic device.

The present invention is also directed to a method of identifying a conductive object on a touch screen of an electronic device. An electronic device including a touch screen is provided. A pattern of engagement points on the touch screen are recognized, such as by capacitive coupling between the object and the touch screen. The pattern of engagement points defines an identification. The identification is associated with an object, and output specific to the associated object is generated.

In one implementation, the pattern of engagement points is a first pattern of engagement points and the object is a first object. A second pattern of engagement points on the touch screen is recognized. The second pattern of engagement points defines a second identification. The second identification is associated with a second object, and a second output specific to the associated second object is generated. An electronic device used with a conductive object may support more than two patterns of engagement points. For example, a current iPad® device recognizes three touch patterns simultaneously on its screen. By recognizing three touch patterns, three objects can be identified or recognized on the screen at the same time. Thus, any quantity of objects on a screen can be identified provided that the electronic device has the ability to recognize that quantity of touch patterns.

### BRIEF DESCRIPTION OF THE DRAWINGS

FIG. 1 illustrates a schematic diagram of a system for identifying an object according to an embodiment of the present invention;

FIG. 2 illustrates a perspective view of an object configured as a toy action figure having an identification recognizable by the disclosed systems;

FIG. 3A illustrates a perspective view of an object configured as another toy action figure having another identification recognizable by the disclosed systems;

FIG. 3B illustrates a perspective view of an object configured as another toy action figure having a third identification recognizable by the disclosed systems;

FIG. 4 illustrates a plan view of an electronic device displaying an application operable with the disclosed objects according to an embodiment of the present invention;

FIG. 4A illustrates a top view of an input object engaging an electronic device;

FIG. 4B illustrates a side view of another input object according to the present invention;

FIG. 5 illustrates a perspective view of another object configured as a key having another identification recognizable by the disclosed systems;

FIG. 6 illustrates a plan view of an electronic device displaying an application operable with the key of FIG. 5;

FIG. 7 illustrates a perspective view of the electronic device of FIG. 6 and the key of FIG. 5;

FIG. 7A illustrates a plan view of the contact points 406 and 408 in a first orientation;

FIGS. 7B and 7C illustrate plan views of the contact points 406 and 408 illustrated in FIG. 7A in different orientations in which the contact points have been moved;

FIGS. 7D and 7E illustrate views of the input object engaging an electronic device and performing a gesture;

FIGS. 7F and 7G illustrate different screen shots of an application that result from the gesture illustrated in FIGS. 7D and 7E;

FIG. 8 illustrates a schematic diagram of a system for identifying an object according to another embodiment;

FIG. 9 illustrates a bottom plan view of another object configured as a toy vehicle having another identification recognizable by the disclosed systems;

FIG. 9A illustrates a bottom perspective view of a chassis of a toy vehicle having an identification recognizable by the disclosed systems;

FIG. 9B illustrates a bottom plan view of another object configured as a toy vehicle having another identification recognizable by the disclosed systems;

FIG. 9C illustrates a schematic view of the contact points detected by an electronic device based on the object illustrated in FIG. 9B;

FIG. 9D illustrates a schematic diagram of a virtual or conceptual grid associated with an object having an identification system;

FIG. 9E illustrates a bottom plan view of another object configured as a toy vehicle having another identification recognizable by the disclosed systems;

FIG. 10 illustrates a plan view of an electronic device displaying an application operable with the toy vehicle of FIG. 9;

FIG. 11 illustrates another plan view of the electronic device of FIG. 10 showing another display output in response to movement of the toy vehicle of FIG. 9;

FIGS. 11A-11D illustrate electronic devices with exemplary display outputs;

FIG. 12 illustrates a plan bottom view of another object including first, second, third and fourth contact members, and defining another identification recognizable by the disclosed systems;

FIG. 13 illustrates an elevational view of the object of FIG. 12 disposed on a touch screen of an electronic device;

FIG. 14 illustrates a front perspective view of another input object according to an embodiment of the invention;

FIG. 15 illustrates a side view of the object illustrated in FIG. 14 in a non-use configuration;

FIG. 16 illustrates a side view of a component of the object illustrated in FIG. 14;

FIG. 17 illustrates a bottom view of the object illustrated in FIG. 14;

FIG. 18 illustrates a side view of the object illustrated in FIG. 14 in a use configuration;

FIG. 19 illustrates a perspective view of another input object according to an embodiment of the invention;

FIG. 20 illustrates a side view of another input object according to an embodiment of the invention;

FIG. 21 illustrates a side view of another input object according to an embodiment of the invention;

FIG. 22 illustrates a rear perspective view of the input object illustrated in FIG. 21 with an electronic device;

FIG. 23 illustrates a side view of the input object illustrated in FIG. 21 in use;

FIG. 24 illustrates a side view of another input object according to an embodiment of the invention;

FIG. 25 illustrates a rear perspective view of the input object illustrated in FIG. 24 with an electronic device;

FIG. 26 illustrates a side view the input object illustrated in FIG. 24 in use;

FIG. 27 illustrates three exemplary screenshots from an application that can be associated with the input objects illustrated in FIGS. 21-26;

FIG. 28A illustrates a perspective view of several different objects configured as keys, each of which has an identification recognizable by the disclosed systems;

FIG. 28B illustrates a top view of several different objects configured as cards, each of which has an identification recognizable by the disclosed systems;

FIG. 28C illustrates a bottom perspective view of the objects illustrated in FIG. 28B;

FIG. 28D illustrates a perspective view of a card according to the invention;

FIG. 28E illustrates a cross-sectional view of the card illustrated in FIG. 28D taken along the line “46E-46E” in FIG. 28D;

FIG. 28F illustrates a perspective view of an electronic device with which the objects illustrated FIGS. 28A-28E is useable;

FIGS. 28G and 28H illustrate side views of the use of an object with the electronic device illustrated in FIG. 28F;

FIG. 28I illustrates a perspective view of the electronic device illustrated in FIG. 28F with a changed touch screen output;

FIG. 28J illustrates a card and an electronic device displaying an image according to the present invention;

FIG. 28K illustrates the use of the card illustrated in FIG. 28J with the electronic device according to present invention;

FIG. 28L illustrates the card and the electronic device illustrated in FIG. 28J displaying another image according to the present invention;

FIG. 28M illustrates a flowchart of an exemplary process of an object and an electronic device according to the present invention;

FIG. 28N illustrates an alternative embodiment of a card according to the present invention;

FIG. 29A illustrates a top perspective view of another input object according to an embodiment of the invention.

FIG. 29B illustrates a bottom perspective view of the input object illustrated in FIG. 29A.

FIG. 29C illustrates a bottom perspective view of an alternative embodiment of the input object illustrated in FIG. 29A.

FIG. 29D illustrates a cross-sectional side view of the input object illustrated in FIG. 29C.

FIG. 29E illustrates an exploded perspective view of the input object illustrated in FIG. 29C.

FIG. 29F illustrates a top perspective view of another embodiment of an input object according to the invention.

FIG. 29G illustrates a top perspective view of some of the internal components of the input object illustrated in FIG. 29F.

FIG. 29H illustrates a side view of some of the internal components of the input object illustrated in FIG. 29F.

Like reference numerals have been used to identify like elements throughout this disclosure.

### DETAILED DESCRIPTION OF THE INVENTION

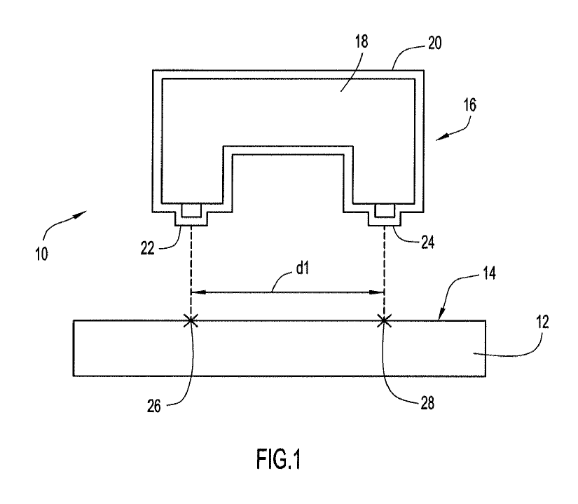

FIG. 1 illustrates a schematic diagram of a system 10 for identifying an object according to an embodiment of the present invention. The system 10 includes an electronic device 12 having a touch screen 14 and a recognizable object 16. In one implementation, the object 16 is conductive and can be placed in contact with or proximate to the touch screen 14 of the electronic device 12, such as an iPhone®, an iPad®, an iPod Touch®, or similar electronic device with a touch screen. Generally herein, the term “electronic device” includes any device that receives and/or generates a signal. An alternative term for “electronic device” is a “smart device.” Some exemplary devices are mobile digital devices, such as an iPhone, iPod, iTouch, iPad, Blackberry, an MP3 player, Android, cell phone, PDA, or a tape recorder.

In one embodiment, the conductive object 16 includes a plastic core 18, which has been substantially coated or encased with a conductive material 20, such as conductive silicone applied via a vacuum metalized process or a die cast conductive paint. Alternatively, the object may be a metal object, a die cast conductive object, a conductive rubber object, a plain rubber object with conductive rubber coating, a co-molded object having some conductive regions, an object with a conductive coating resulting from being dipped into a conductive material, such as copper, or a non-conductive object with conductive patterns applied to its surface, such as via metallic or foil stamps, conductive painted patterns, conductive decals, or conductive rubber appliqué. Also, the object may be either hard or soft. When a user holds the object 16, the charge in the touch screen 14 at the location or locations where the object 16 is positioned proximate to or in contact with the touch screen 14 changes because some of the charge is transferred to the user due to the conductive coating 20 on the object 16 and the user contacting the coating 20. The result is that the device can determine the location or locations at which there is a change in capacitance of the touch screen 14 as caused by the change in the charge of a layer of the touch screen 14. Thus, the object 16 may be capacitively coupled to the touch screen 14, thereby allowing the contact point or points of the object 16 to be detected. Alternatively, the user may be capacitively coupled to the touch screen 14 through object 16, thereby allowing the contact point or points of the object 16 to be detected.

The object 16 includes a first contact member 22 engageable with the touch screen 14 and a second contact member 24 engageable with the touch screen 14. The contact members 22, 24 are spaced from each other. The electronic device 12 senses the locations of each of the contact members 22, 24 when the contact members 22, 24 engage or are proximate to the touch screen 14. The electronic device 12 then determines the distance d1, such as a quantity of pixels, between the two sensed contact (or proximity) points 26, 28 of the contact members 22, 24 on the touch screen 14, respectively. The distance d1 between the contact points 26, 28 corresponds to the spacing between the contact members 22, 24. This distance d1 is associated with the particular object 16, such as a particular toy figure or toy vehicle. Thus, the conductive object 16, when placed on the touch screen 14, conducts the charge from a user to the touch screen 14, which is detected by the device 12 as a recognizable pattern or geometric arrangement of touches or contact points 26, 28. The pattern of contact points 26, 28 defines an identification for the object 16. According to the present invention, the term “identification” of an object and the term “identifying” an object may encompass multiple levels of information determining. In one embodiment, the identification is the recognizing or confirming that the object is not one or more human's fingers. In particular, this confirmation may be a determination that the object is a proper object to be used with a particular application operating on the electronic device. For example, the application may be looking for a particular pattern of contact points, indicating that the object is a proper or correct object to be placed in contact with or proximate to the touch screen 14, before the application provides the user with access to a different part of the application or with other information. In another embodiment, the identification is the recognizing or confirming that the object proximate to or in contact with the touch screen 14 is of a particular category of objects, such as toy vehicles or figures. In this implementation, if the application confirms that the object is of a particular type or category that is proper or correct to be used with the application, then the application can provide additional content or information or access to different portions of the application. In another embodiment, the identification is unique to the particular object 16 and encompasses unique, specific information, such as an object-specific identity. At this level of identification, the exact identity of the object can be determined and content or information specific to that object can be output or obtained.

Thus, the particular object 16 is identified based on the distance d1 between the sensed contact points 26, 28. The contact members 22, 24 define a pattern of contact points 26, 28 on the touch screen 14 (when the object 16 is engaging or proximate to the touch screen 14), which is recognizable by the electronic device 12 for identifying the object 16. Further, the location of the object 16 on the touch screen 14 may be determined based on the location of the contact points 26, 28 on the touch screen 14.

The specific configuration of the object usable with the disclosed systems herein may vary. For example, the object may be a configured as a toy figure, a toy vehicle, a toy building, or some other structure.

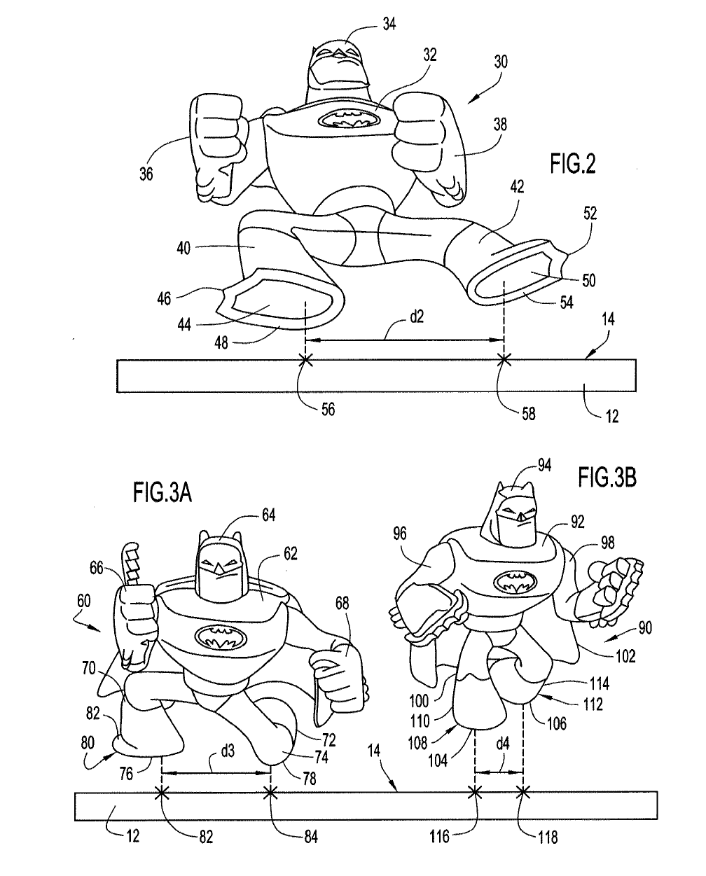

Referring to FIG. 2, in one embodiment, the object is configured as a toy action figure 30. The figure 30 includes a torso 32 and appendages, such as a head 34, arms 36, 38 and legs 40, 42. An underside 44 of a foot 46 of the leg 40 includes a first contact member 48, and an underside 50 of a foot 52 of the other leg 42 includes a second contact member 54. When placed on or proximate to the touch screen 14 of the electronic device 12, the first and second contact members 48, 54 define first and second contact points 56, 58. The electronic device 12 senses the contact points 56, 58 and considers them to be figures of a human. A distance d2 between the contact points 56, 58 is determined by the electronic device 12. The determined distance d2 is then associated with an identification of the specific toy figure 30.

In one embodiment, the torso 32 is rotatable relative to the legs 40, 42. The head 34 and/or arms 36, 38 may also rotate and/or move relative to the torso 32. However, the legs 40, 42 and feet 46, 52 of the figure 30 remain in a fixed position relative to each other. Thus, the spacing between the first and second contact members 48, 54, and distance d2 between the corresponding contact points 56, 58, remains constant. As a result, the identification of the action figure 30 remains constant.

An action figure 60 having an identification different than the identification associated with figure 30 is illustrated in FIG. 3A. Similar to action figure 30, action figure 60 also includes a torso 62, a head 64, arms 66, 68 and legs 70, 72. The arms 66, 68, legs 70, 72 and/or head 64 of the figure 60 have a different configuration compared to the corresponding appendages of the figure 30. The legs 70, 72 are configured so that the figure 60 appears to be kneeling down on a knee 74 of the leg 72. The leg 70 includes a first contact member 76, and the other leg 72 includes a second contact member 78. In particular, an underside 80 of a foot 82 of the leg 70 may include the first contact member 76. A portion of the knee 74 engageable with the touch screen 14 of the electronic device 12 includes the second contact member 78. When placed on the touch screen 14, the first and second contact members 76, 78 define first and second contact points 82, 84, respectively. The distance d3 between the contact points 82, 84 corresponds to the distance between the contact members 76, 78. The electronic device 12 may therefore determine the distance d3 when the figure 60 is placed on or is near the touch screen 14. The identification of the figure 60 is thereby recognized based on the pattern of contact points 82, 84 generated by the contact members 76, 78.

Another action figure 90 having a unique identification is illustrated in FIG. 3B. Action figure 90 includes a torso 92, a head 94, arms 96, 98 and legs 100, 102. The arms 96, 98, legs 100, 102 and/or head 94 of the figure 90 may have a different configuration compared to the corresponding appendages of the figures 30, 60. The legs 100, 102 are configured so that the figure 90 appears to be walking forward. The front leg 100 includes a first contact member 104, and the back leg 102 includes a second contact member 106. In particular, an underside 108 of a foot 110 of the front leg 100 includes the first contact member 104, and an underside 112 of a foot 114 of the back leg 102 includes the second contact member 106. When placed on the touch screen 14, the first and second contact members 104, 106 define first and second contact points 116, 118 on the touch screen 14. The distance d4 between the contact points 116, 118 is determined by the electronic device 12. The determined distance d4 is associated with an identification that is recognized as the figure 90.

Thus, each of the pairs of contact points 56, 58 or 82, 84 or 116, 118 generated by each of the corresponding figures 30, 60, 90 defines a distinct pattern or spacing of contact points. Each specific pattern of contact points is associated with a particular figure. In this way, the electronic device 12 recognizes a particular figure 30, 60 or 90. When a figure is identified, a figure specific output, which may include audio and/or visual components, may be generated by the electronic device. The output may include sound effects, access to previously locked material (such as features, game levels, a diary, etc.), the opening of an online world, a change in the state of a game being played, or the addition of features to a game or application on the electronic device. The use of multiple figures provides the ability for real time competitive gaming on an electronic device, such as an iPad. In an alternative embodiment, a figure may have a fixed base that provides a lower surface area that is larger than the surface area of the feet or legs of figures 30, 60, and 90. The larger surface area of a base enables more contact members to be located on the bottom of the base. In addition, the larger surface area of the base provides a greater area over which contact members can be positioned and spread apart, thereby increasing the quantity of different identifications that can be associated with the base and figure. Also, in the embodiment of a figure with a base, a figure can be non-conductive as long as the base with the identifying contact members is conductive.

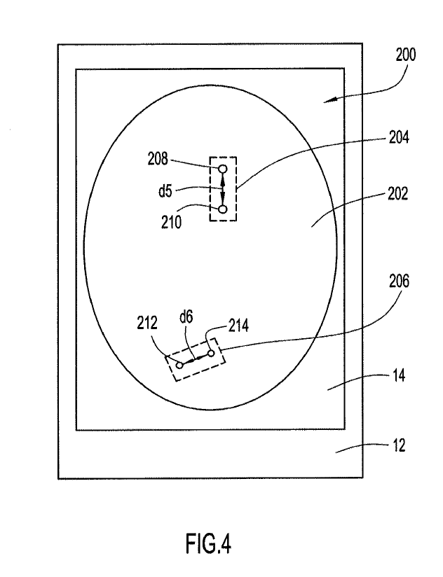

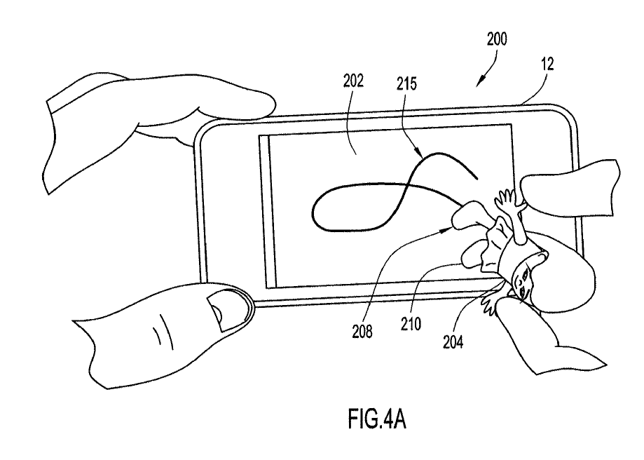

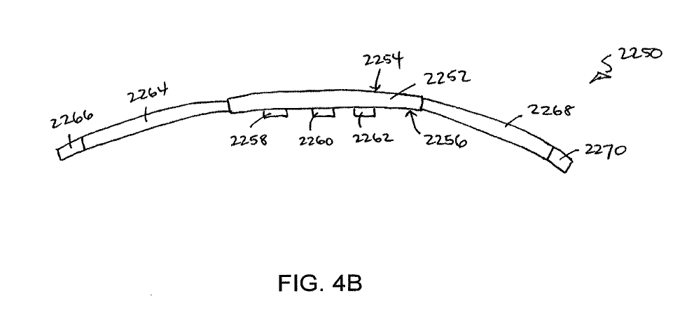

Referring to FIGS. 4 and 4A, an application (e.g. a game) may be operable with the electronic device 12. For example, an ice skating game 200 may be operable on the electronic device 12. The device 12 displays a simulated ice rink 202 on the touch screen 14. One or more objects, such as toy figures 204, 206 (shown in phantom in FIG. 4 and shown in FIG. 4A), may be placed on the touch screen 14. One of the figures 204 includes contact members 208, 210 (such as feet) spaced by a distance d5, and the other figure 206 includes contact members 212, 214 spaced by another distance d6 different than distance d5. When the figure 204 is placed on the touch screen 14 so that its contact members 208, 210 engage or are proximate to the touch screen 14, a specific pattern of contact points (spaced by distance d5) is recognized by the electronic device 12. Similarly, when the other figure 206 is placed on the touch screen 14 so that its contact members 212, 214 engage or are proximate to the touch screen 14, a different pattern of contact points (spaced by distance d6) is recognized by the electronic device 12. The identifications of the corresponding figures 204, 206 are associated with each of the figures 204, 206 disposed on the touch screen 14. Thus, the electronic device 12 recognizes the identification of each figure 204, 206, as well as the location of each particular figure 204, 206 on the touch screen 14.

As shown in FIG. 4, more than one figure 204, 206 may be placed on the touch screen 14. Thus, the electronic device 12 simultaneously recognizes the identification and location of multiple figures 204, 206 on the display screen 14. Further, any movement of the figures 204, 206 on the touch screen 14 (such as when a user slides the figures 204 and/or 206 across the touch screen 14) is tracked by the electronic device 12. Referring to FIG. 4A, as the toy figure 204 is moved along the touch screen a line 215 is generated by the application that corresponds to the path along which the toy figure 204 has traveled or “skated.” The line 215 can remain on the screen while the application runs. In addition, an audible output resembling ice skate blades traveling along the ice is generated as the figure moves along the display simulating ice. It should be understood that only one figure 204 or 206 may alternatively be used at a given time with the device 12. Alternatively, additional figures may be used (e.g., three or more figures) with the electronic device 12, whereby all figures are recognized by the device 12.

Upon recognizing the identification and/or location of the figure 204 and/or 206, the electronic device 12 may generate a visual and/or audio output in response thereto. For example, an image associated with the figure 204 and/or 206 (e.g., such as an image representing the figure wearing skates) may be displayed on the touch screen 14. The image may be aligned with or proximate to the corresponding physical figure 204 or 206 disposed on the touch screen 14, and move along with the figure 204 or 206 as the user or users move the figures 204 and 206. In different embodiments, the figures 204 and 206 can interact and the output generated and displayed on the touch screen 14 includes a theme corresponding to the theme of the figures 204 and/or 206.

It should be understood that the particular theme of the object and/or application may vary. For example, the toy figure(s) and/or the associated application(s) may be configured as wrestlers, soldiers, superheroes, toy cars, underwater vehicles or creatures, space vehicles or creatures, etc. In an embodiment using wrestler action figures, when a particular wrestler is placed into contact with the touch screen, that wrestler's signature music and/or phrases can be generated by the electronic device.

In different embodiments of the invention, some exemplary applications include a cataloging application which can track the user's figure collection, share stats, etc. Another example application is to use the figures or accessories as keys into an online game, either as play pieces or tokens to enable capabilities, unlock levels or the like.

In one embodiment, the object to be identified by the electronic device 14 can be a weapon that is useable with the figures 30, 60, 90. For example, the object can be a weapon, such as a sword, that has two or more identifiable contact members projecting therefrom. Each of the contact members is engageable with or can be placed proximate to the touch screen 14 of the electronic device 12 when the user holds the weapon near the touch screen 14. If the electronic device 12 is running an application that includes a simulated battle with figures 30, 60, and 90, and when prompted by the electronic device 12, the user engages the weapon with the touch screen 14, the electronic device 12 can identify the weapon from its contact members and a simulated weapon in the game on the electronic device 12 can be associated with one or more of the figures 30, 60, and 90. Accordingly, the user can play with the weapon and one or more of the figures 30, 60, and 90, while the game running on the electronic device 12 also includes representations of the figures 30, 60, and 90 and the weapon.

A side view of an alternative embodiment of an input object is illustrated in FIG. 4B. In this embodiment, the input object 2250 is a belt, such as a full-scale title belt such as those used by the WWE. The object 2250 includes a main body portion 2252 with an outer surface 2254 and an opposite inner surface 2256. The outer surface 2254 may contain an ornamental appearance that corresponds to the title or rank of the holder of the belt. Coupled to the body portion 2252 are belt portions 2264 and 2268 with couplers 2266 and 2270 that can be coupled together so that a person can wear the belt 2250. As shown, the body portion 2252 includes several contact members 2258, 2260, and 2262 coupled thereto that can be used with a touch screen of an electronic device. The electronic device can identify the particular object 2250 based on the contact members 2258, 2260, and 2262 and provide an output associated therewith.

Another embodiment of an object usable with the disclosed system is illustrated in FIG. 5. The object is configured to resemble a key 300. The key 300 includes a handle portion 302 and an opposing end portion 304 having spaced projections 306, 308. One of the projections 306 includes a first contact member 310, and the other projection 308 includes a second contact member 312. The contact members 310, 312 are spaced by a distance d7. In this embodiment, the key 300 includes a conductive coating covering the key 300 and defining the outer surface thereof. When a user holds the key 300, a charge from the user passes along the conductive outer coating on the key 300 and to the contact members 310, 312.

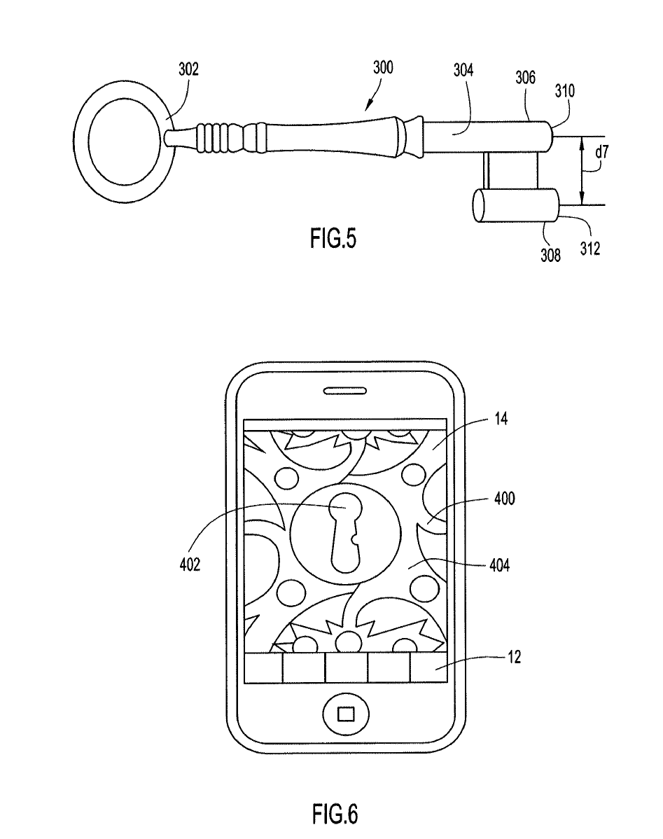

Referring to FIG. 6, another application operable with an electronic device is illustrated. The application is a game 400 that includes an environment through which a user must navigate. The environment may include passages, locked doors, hidden treasure, etc. In order to pass through a particular passage, or to advance to another level, the user may be prompted to engage a particular object on the touch screen 14. For example, at a point in the game 400, a keyhole 402 of a lock 404 is displayed on the touch screen 14. In order to ‘unlock’ the lock 404, the user places the spaced projections 306, 308 and thus the first and second contact members 310, 312 against the touch screen 14 in positions aligned with the keyhole 402.

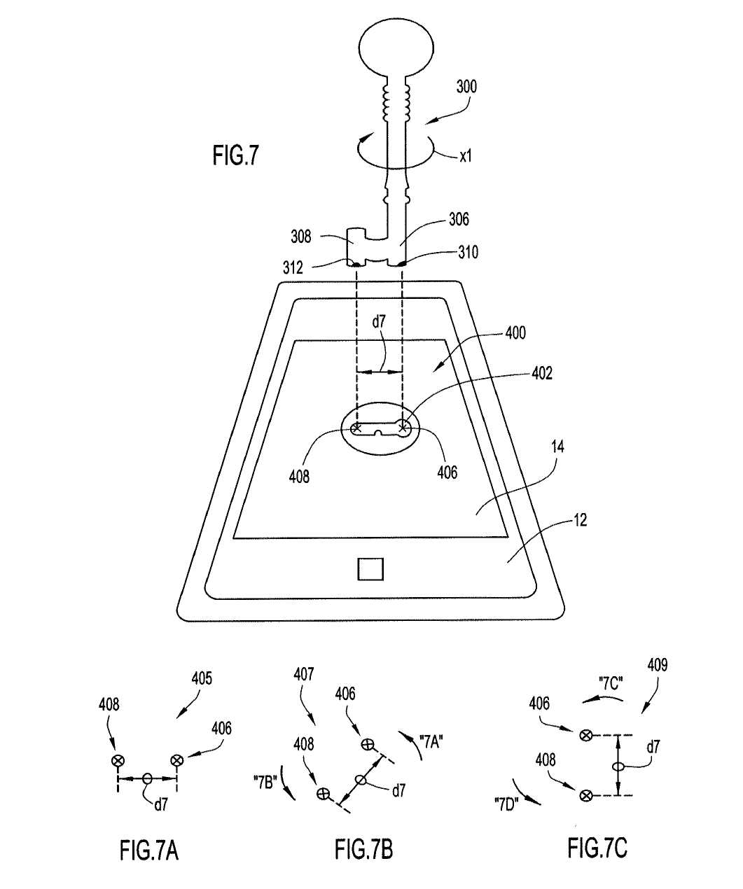

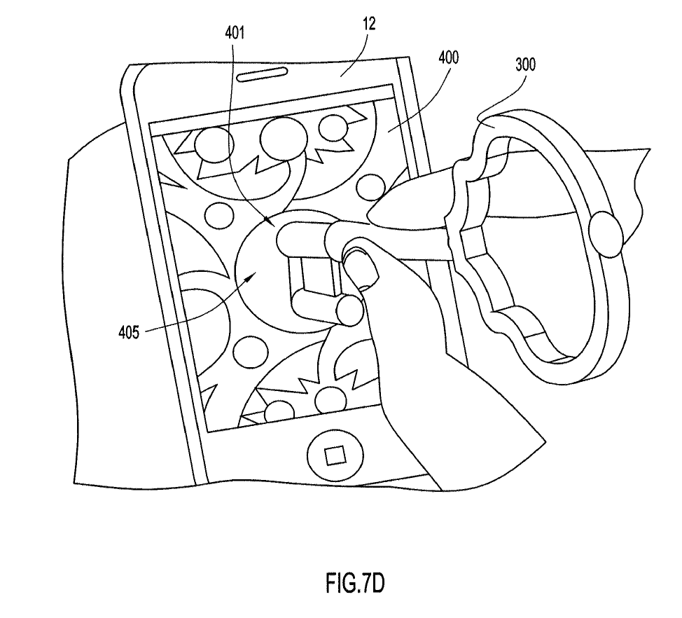

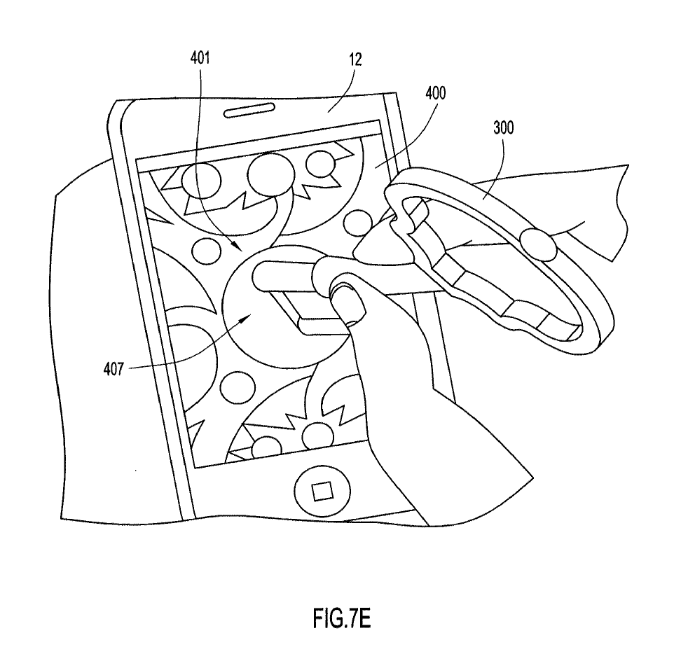

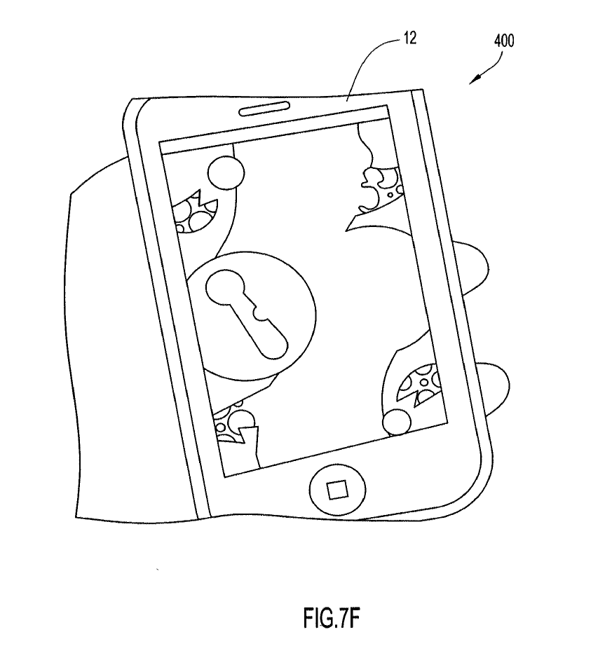

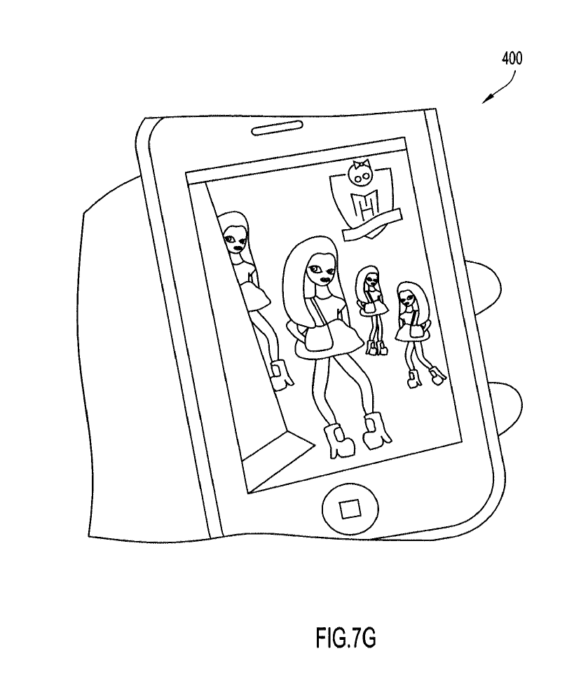

Referring to FIG. 7, when projections 306, 308 of the key 300 are properly aligned with the keyhole 402, the contact members 310, 312 engage the touch screen 14 so that a specific pattern of contact points 406, 408 (spaced by distance d7) is sensed and recognized by the electronic device 12. The electronic device 12 then associates the pattern and location of contact points 406, 408 with the key 300. The key 300 may then be rotated in a direction X1 (e.g., 90° rotation about a longitudinal axis of the key 300). The electronic device 12 detects the corresponding movement of the contact points 406, 408, and in turn generates a visual and/or audio output associated with the movement. For example, a rotation of the keyhole 402 may be displayed on the touch screen 14, followed by the image of the lock 404 turning and being unlocked (or an associated displayed door swinging open or vanishing). The user may then navigate past the lock 404 in the game 400.

The system is capable of identifying a gesture using the object (e.g., the key), as well as the object itself. A gesture is the movement of contact points across the touch screen. For example, a contact pattern, such as two contact points, can be made distinct from a human's fingers by requiring a gesture which is difficult to make with fingers. In one example, the key-like conductive object 300 must be rotated some number of degrees, such as 90 degrees. It is difficult, if not impossible, for a user to make this gesture with his or her fingers, while maintaining a constant finger spacing. Accordingly, this gesture component of the system increases the ability to generate an output in response to a particular gesture via the key object-screen interaction, and two distinguish such a gesture from a human attempt to mimic the gesture without the key object. A simple two or three contact ID object, coupled with a requirement of a particular gesture or gestures using the object, creates a more expansive identification system with respect to different applications and outputs that can be generated.

Referring to FIGS. 7A-7C, the process of determining the movement of an object relative to the electronic device 12 is illustrated. The application running on the electronic device 12 is configured so that it can determine the distance between the contact points 406 and 408, which are caused by the contact members 310 and 312. The contact members 310 and 312 of the key 300 are a fixed distance apart from each other. When the application determines that the distance d7 between the contact points 406 and 408 is constant while one or both of the contact points 406 and 408 moves relative to the screen 14, the application determines that the object 300 is causing the contact points 406 and 408 and not a human's fingers, for which the constant distance between touch points is difficult to maintain.

Referring to FIG. 7A, when the contact points 406 and 408 are in a first orientation 405, such as that illustrated in FIG. 7, the contact points 406 and 408 are spaced apart by a distance d7. In FIG. 7B, the contact points 406 and 408 have moved along the directions of arrows “7A” and “7B,” respectively, to a different orientation 407. As shown, the distance between the contact points 406 and 408 remains the same. Similarly, the contact points 406 and 408 have moved along the direction of arrows “7C” and “7D,” respectively, to a different orientation 409, and have the same dimension d7 therebetween.

The application continuously checks the distance d7 and tracks the precise distance between the contact points 406 and 408 as the object moves. In one embodiment, once movement of one or both of the contact points 406 and 408 is detected, the application checks the distance every 1/1000^{th} of a second. The distance between contact points 406 and 408 is calculated each time the application checks the distance.

Referring to FIGS. 7D and 7E, an exemplary gesture involving the input object 300 and an exemplary application 400 running on the electronic device 12 are illustrated. In FIG. 7D, the object 300 is engaged with a particular region or area 401 on the touch screen 14. This orientation of object 300 corresponds to the orientation 405 illustrated in FIG. 7A. In FIG. 7E, the object 300 is rotated or moved to orientation 407 (also shown in FIG. 7B) and the region 401 is also rotated because the application has determined that the distance between the contact points created by object 300 has remained fixed, thereby confirming that it is a proper input object and not the fingers of a human.

In FIG. 7F, a screenshot shows the door portions in the application separating as a result of a correct or proper movement or gesture of the object 300 with the application 400. In FIG. 7G, a screenshot of the application 400 is shown that is exemplary of the interior or inside of the closed doors illustrated in FIGS. 7D and 7E. Various audible and/or visible outputs can be generated by the device upon the unlocking of the door as described above.

It should be understood that the specific configuration of the object usable with a gaming or other application may vary. For example, the object may be configured as a weapon, jewelry, food or an energy source, or any other device or structure related to the particular game. Alternatively, the object may be configured as a knob, which may be placed on the screen 14 and rotated and/or slid relative to the touch screen 14 for increasing volume, scrolling through pages, or triggering some other visual and/or audio output or event. The object may be configured as a playing card, whereby the distance between spaced contact members identifies the particular suit and number (or other characteristic) of the card.

An object 500 according to another embodiment is illustrated in FIG. 8. The object 500 includes first and second contact members 502, 504 spaced by a distance d8. The object 500 also includes a third contact member 506. First, second and third contact points 508, 510, 512 are detected on the touch screen 14 by the electronic device 12 when the first, second and third contact members 502, 504, 506 engage or are proximate to the touch screen 14. The first and second contact points 508, 510 are spaced from each other by distance d8 (corresponding to the spacing between the first and second contact members 502, 504). The third contact point 512 is spaced from a midpoint 514 between the first and second contact points 508, 510 by another distance d9. The arrangement of the first, second and third contact members 502, 504, 506 of the object 500, as defined by distances d8 and d9, define a unique pattern of contact points 508, 510, 512.

In one implementation, the electronic device 12 determines the distance d8 between the first and second contact points 508, 510 in order to determine the specific identity and location of the object 500 in contact with or proximate to the touch screen 14. If the distance d8 is a particular distance, the electronic device 12 then determines the distance d9 between the midpoint 514 of the first and second contact points 508, 510 and the third contact point 512 in order to determine the orientation of the object 500.

In another implementation, the electronic device 12 first determines the distance d8 between the first and second contact points 508, 510 to determine a toy category associated with the object 500. For example, based on a distance d8 between the first and second contact points 508, 510 of a particular distance, such as 64 pixels (about 10 mm), which spacing is provided on all toy cars usable with the system or the particular application, the electronic device 12 may determine that the object 500 is a toy car. The electronic device 12 then determines the specific identify of the object 500 within the toy category based on the distance d9 between the midpoint 514 and the third contact point 512. For example, based on a distance d9 between the midpoint 514 and the third contact point 512 of 55 pixels, the electronic device 12 may recognize the toy car to be a black van with red wheels. A different distance d9 could be representative of a white racing car. Further, the electronic device 12 may determine the location of the object 500 based on the detected pattern of contact points 508, 510, 512.

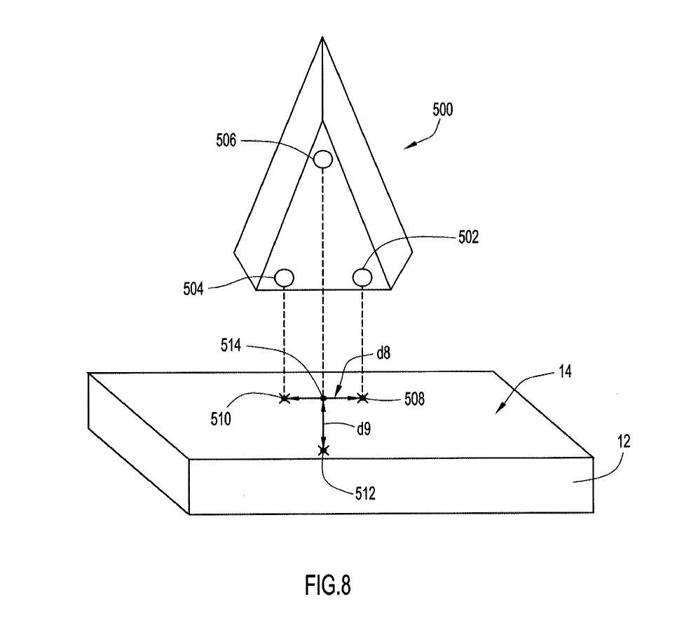

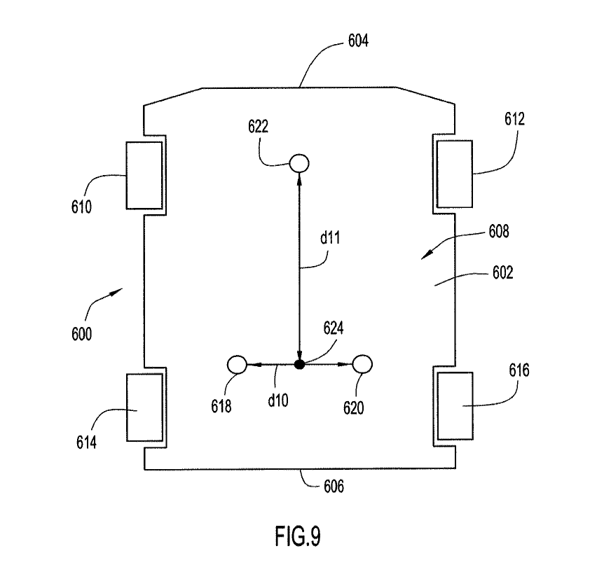

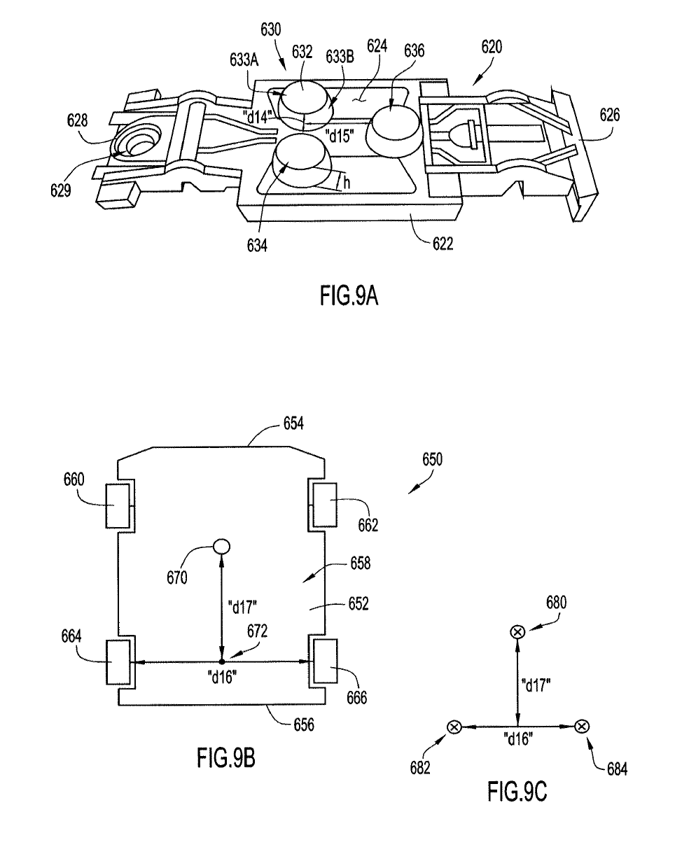

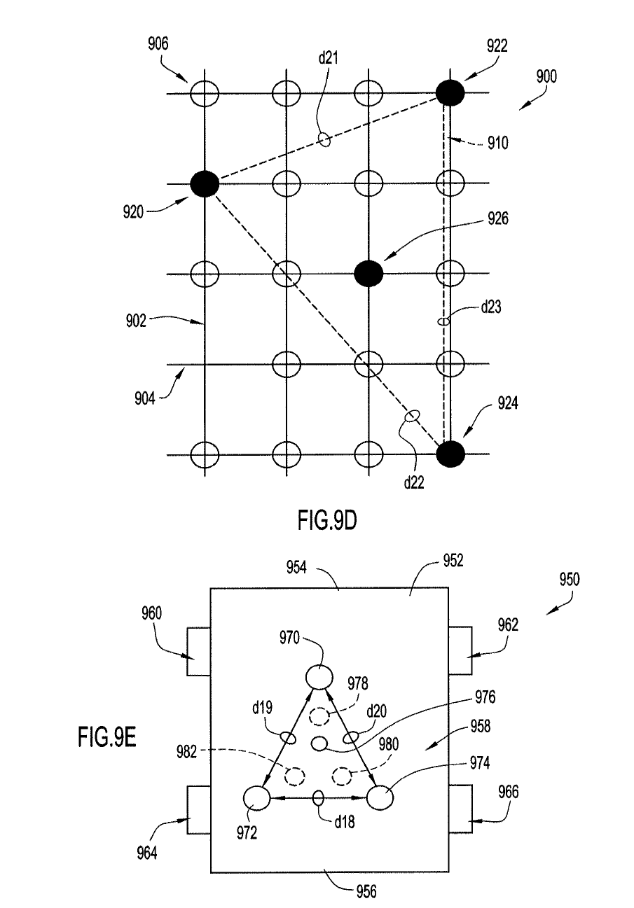

Referring to FIG. 9, an object usable with the disclosed system is configured as a toy vehicle 600. The toy vehicle 600 can be just one of many toy vehicles that can be identified by the system. A bottom view of the toy vehicle 600 is shown in FIG. 9. The vehicle 600 includes a chassis or body 602 having a front end 604, a rear end 606, and an underside 608. Wheels 610, 612, 614, 616 are coupled to the body 602. The wheels 610, 612, 614, 616 may be rotatable or fixed relative to the body 602. First and second contact members 618, 620 are coupled to and project outwardly from the underside 608. The first and second contact members 618, 620 are spaced by a distance d10. A third contact member 622 is also coupled to and projecting outwardly from the underside 608. The third contact member 622 is spaced from a midpoint 624 between the first and second contact members 618, 620 by a distance d11. Distance d10 is different than the distance between contact members 618 and 622 and the distance between contact members 620 and 622, thereby allowing the electronic device to properly categorize the object using contact members 618, 620 initially.

The base distance between contact points 618 and 620 is dimension d10, which can be a fixed distance such as 64 pixels discussed above. For different objects in a group that have the same dimension d10 (which means that the objects are in the same category), the dimension d11 can be a multiple of dimension d10. For example, three different toy vehicles can have the same dimension d10, but different dimensions d11 that are integer increments of dimension d10, such as one, two, and three times dimension d10, respectively. Alternatively, if a greater quantity of toy vehicles is contemplated and space is limited, dimension d11 can be smaller increments of dimension d10, such as increments of 1.1, 1.2, 1.3, etc. of dimension d10.

Referring to FIG. 9A, a bottom perspective view of a chassis for a toy vehicle is illustrated. In this embodiment, the chassis 620 can be a molded plastic object with a conductive coating. The chassis 620 can be electrically coupled to the touch of a human holding the toy vehicle so that the capacitance or charge at a location of the touch screen changes based on contact thereof from the human through the chassis 620. For example, a child may touch one or more sides of the chassis 620 while holding the toy vehicle. Alternatively, there may be a conductive member or piece of material that is connected to the chassis 620 and extends through the body of the toy vehicle so the child can touch the conductive member. The chassis 620 includes a body 622 with a lower surface 624 and opposite ends 626 and 628, with a mounting aperture 629 located proximate to end 628.

The chassis 620 includes an identification system 630 that can be detected and used by the electronic device 12 to identify the object of which chassis 620 is a part and the orientation of the object. In this embodiment, the identification system 630 includes several bumps or protrusions or contact members 632, 634, and 636, that extend outwardly from lower surface 624. Protrusion 632 includes a lower surface 633A and a side wall 633B that extends around the protrusion 632. The distance between contact members 632 and 634 is dimension d14 and the distance between contact member 636 and the line between contact members 632 and 634 is dimension d15. In one embodiment, dimension h, which is the height or distance that the protrusions extend from surface 624, is slightly greater than the distance that the outer surface of wheels of the toy vehicle to which chassis 620 is coupled extend relative to the lower surface 624. This greater height allows the contact members 632, 634, and 636 to engage the touch screen of the electronic device. In other embodiments, the dimension h for one or more of contact members 632, 634 and 636 is slightly less than the distance that the outer surface of wheels of the toy vehicle to which chassis 620 is coupled extend relative to the lower surface 624. In this latter case, contact members 632, 634 and/or 636 might only be detected by the screen in the event that the user pressed down upon the vehicle, causing the axles to flex slightly and the contact members to come into closer proximity to the screen, at which point they would be detectable by the system. The dimension h may also be adjusted such that while it is slightly less than the distance that the outer surface of wheels of the toy vehicle to which chassis 620 is coupled extend relative to the lower surface 624, the contact members are nevertheless detectable by the system due to their close proximity (though not contact) with the screen.

Protrusions 634 and 636 are similarly constructed to protrusion 632. In one embodiment, the protrusions 632, 634, and 636 can be formed integrally with the chassis. In another embodiment, the protrusions 632, 634, and 636 can be formed separate from the chassis and coupled thereto, using a coupling technique, such as an adhesive, bonding, melting, welding, etc. While protrusions 632, 634, and 636 are illustrated as being generally frusto-conical, in different embodiments, the configurations of the protrusions may be a cylinder, a cube, a semisphere, and a rectangular prism.

Referring to FIG. 9B, a bottom view of another object usable with the disclosed system is configured as a toy vehicle 650 is illustrated. The vehicle 650 includes a chassis or body 652 having a front end 654, a rear end 656, and an underside 658. Several wheels 660, 662, 664, 666 are coupled to the body 652 and are either rotatable or fixed relative to the body 652.

In this embodiment, a single contact member 670 projects outwardly from the underside 658. Wheels 664 and 666 are conductive and are either made of metal or other conductive material or are formed of a non-conductive material and coated with a conductive coating. The wheels 664 and 666 are spaced apart by a distance d16. The contact member 670 is spaced from a midpoint 672 between wheels 664 and 666 by a distance d17. Distance d17 is different than the distance between the wheels 664 and 666, thereby allowing the electronic device to properly categorize the object using contact members 664 and 666 initially.

The resulting contact points on the screen or surface of the electronic device are illustrated in FIG. 9C. Contact member 670 causes contact point 680 and wheels 682 and 684 cause contact points 682 and 684 with dimensions d16 and d17 as shown. When the toy vehicle 650 is placed proximate to or in contact with the electronic device 12, and is moved around relative to the device 12, the dimensions d16 and d17 remain constant. As discussed above, the application running on the electronic device 12 continuously checks to see if the distances d16 and d17 remain constant through the motions of the toy vehicle 650. If the distances remain constant, the application can then determine that the object is the toy vehicle 650 and not the touches of a human.

Referring to FIG. 9D, a schematic diagram of a virtual or conceptual grid that is associated with a toy object having an identification system is illustrated. In this embodiment, the grid 900 is formed by two sets 902 and 904 of perpendicular lines. The intersections of the lines are illustrated as nodes or points 906. This conceptual grid 900 is mapped onto the toy object and is not present on the electronic device. If the grid 900 can be matched or mapped onto the object, then the identification of the object can be determined and used by the application and device, as described below. The grid 900 may be based on geometric ID patterns that have fixed reference points that are common to all ID patterns as well as one or more ID specific points that are unique to one of the toy objects. The fixed points may be asymmetric and provide vector information. Each pattern of fixed reference points and ID specific points may be unique and distinguishable in all orientations.

In this embodiment, the identification system of an object is represented by several contact points. The profile of the system is shown as 910 in FIG. 9D. While the object may have any shape or configuration, in this embodiment, the profile 910 has a generally triangular shape defined by contact points 920, 922, and 924. When the electronic device senses the contact points 920, 922, and 924, the application running on the electronic device determines whether the distances between the contact members and the contact points can be mapped onto a grid.

In other words, contact points 920 and 922 are spaced apart by a distance d20, contact points 920 and 924 are spaced apart by a distance d21, and contact points 922 and 924 are spaced apart by a distance d22. When the object, such as a toy vehicle, is placed onto the screen of the electronic device, the device detects the locations of the contact points 920, 922, and 924. The device then manipulates the grid 900 to match up the contact points 920, 922, and 924 with different nodes 906, as shown in FIG. 9D. If each of the contact points 920, 922, and 924 is matchable with a node 906, the application can determine that the contact points 920, 922, and 924 are representative of a particular type or category of object, such as toy vehicles. Accordingly, the object can be identified as a toy vehicle. In addition, the orientation of the object can be determined once the contact points 920, 922, and 924 are matched up to grid 900. If the device cannot determine that the contact points 920, 922, and 924 are matchable with a grid 900, then the device determines that the object is not the particular type expected or associated with the running application.

In this embodiment, the identification system generates a fourth contact point 926. The fourth contact point 926 is spaced apart from the profile 910 defined by contact points 920, 922, and 924. For example, the fourth contact point 926 is located within the perimeter of profile 910 in the embodiment illustrated in FIG. 9D. The location of the fourth contact point 926 is used to determine the particular identity of the object, such as a specific truck or car.

Referring to FIG. 9E, a bottom plan view of another object with an identification system is illustrated. In this embodiment, the toy vehicle 950 includes a body or chassis 952 with a front end 954, a rear end 956, and a lower surface 958. Several wheels 960, 962, 964, and 966 are rotatably or fixedly coupled to the body of the vehicle 950. In different embodiments, one or more of the wheels 960, 962, 964, and 966 can be made of a conductive material or made of a non-conductive material with a conductive coating or layer applied thereto.

The toy vehicle 950 also includes an identification system located on the lower surface 958. The identification system includes contact members or protrusions 970, 972, and 974 that are spaced apart from each other. As shown, contact members 970, 972, and 974 form a generally triangular shape, which would result in the contact points 920, 922, and 924 on the electronic device, as illustrated in FIG. 9D. The distances d18, d19, and d20 in FIG. 9E correspond to the distances d21, d22, and d23, respectively, in FIG. 9D. The contact members 970, 972, and 974 are used to identify the particular category of object 950.

A fourth contact member 976 is provided that is used to identify the specific object 950. For toy vehicle 950, contact member 976 is located in a particular spot relative to the other contact members 970, 972, and 974. This spot is associated with one toy vehicle. For different toy vehicles, the fourth contact member 976 and be placed at any one of the different locations 978, 980, and 982 that are shown in dashed lines.

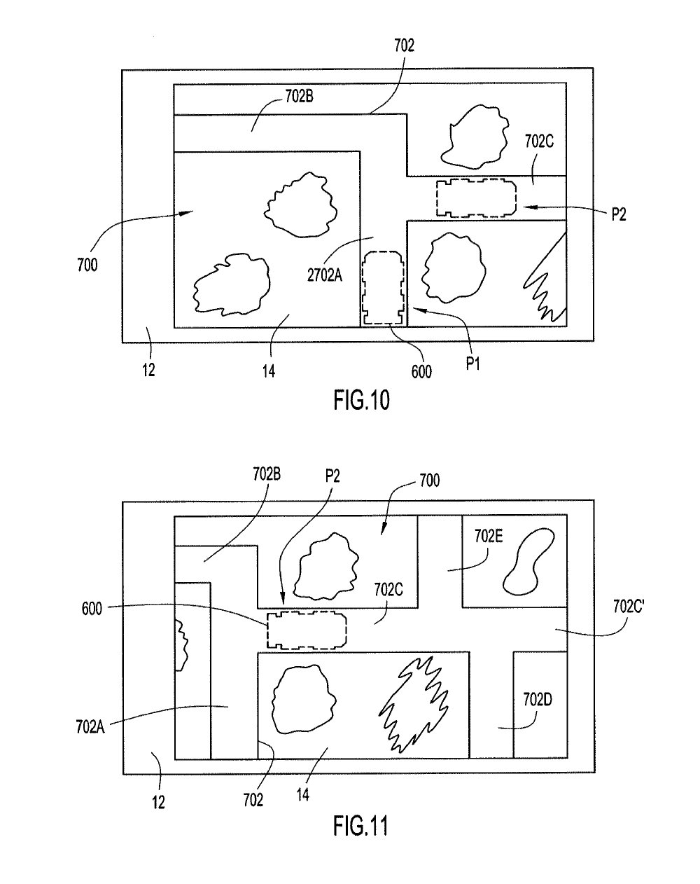

Referring to FIG. 10, an application operable with the electronic device 12 and the toy vehicle 600 is illustrated. The application is a game 700 including a roadway 702 along which a user may ‘drive’ or ‘steer’ the vehicle 600. Portions 702A, 702B and 702C of the roadway 702 are displayed on the touch screen 14. The vehicle 600 may be placed anywhere on the touch screen 14. The determination that the object is a toy vehicle 600 is made by the electronic device 12 based on the distance d10 between the first and second contact points (associated with the first and second contact members 618, 620 engaging or proximate to the touch screen 14). For example, the vehicle 600 may be placed on portion 702A of the roadway 702 so that the vehicle 600 (shown in phantom) is in a position P1. The identity and location of the vehicle 600 on the touch screen 14 are then recognized, as described above. The third contact point (corresponding to the point of engagement of the third contact member 622) is also detected and identified. The electronic device 12 recognizes the orientation of the front end 604 of the vehicle 600 based on the detection of the third contact member 622 and the distance d11.

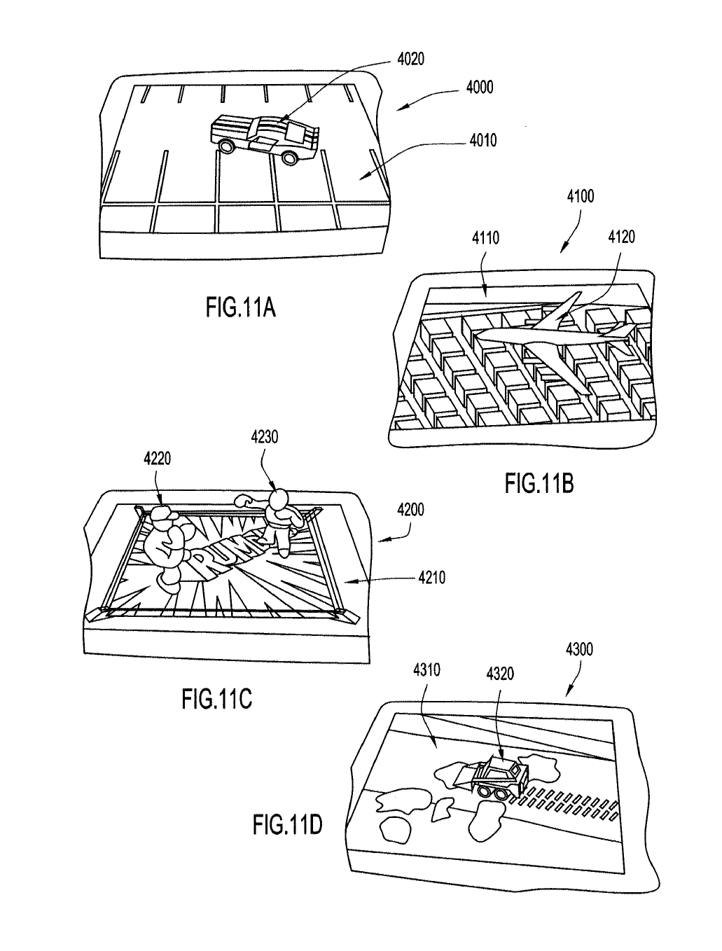

With continued reference to FIG. 10, the user may slide the vehicle 600 upwardly along portion 702A of the roadway 702, and then rotate or ‘turn’ the vehicle 600 to the right (relative to the user) so that the vehicle 600 (shown in phantom) proceeds onto portion 702C of the roadway 702, shown at a position P2. The identity and location of the vehicle 600 are recognized and tracked by the electronic device 12 as the vehicle 600 is moved on the touch screen 14 by the user. In addition, a visual and/or audio output may be generated and displayed in response to the movement of the vehicle 600 on the touch screen 14. For example, as shown in FIG. 11, portions 702A, 702B and 702C of the roadway 702 have shifted to the left (relative to the user) as the vehicle 600 was moved from position P1 on portion 702A to position P2 on portion 702C. In addition, portions 702C′ of the roadway 702, as well as newly displayed portions 702D, 702E, are displayed as the vehicle 600 proceeds toward the right of the touch screen 14 (relative to the user). Thus, the roadway 702 changes, simulating virtual movement of the vehicle 600, as well as in response to actual movement of the vehicle 600 on the touch screen 14. In some embodiments, the electronic device 12 can generate various audible outputs associated with the traveling of the vehicle 600 off the road when the movement of the vehicle 600 is detected at a location that is not part of the road in the application.

Although orientation of an object may be detected via detection of first, second and third contact members, in some embodiments, the orientation of the object may be automatically determined or specified by the application. As such, the third detection point may be obviated for some applications. For example, an object including only two contact members (e.g., the figures described above) may be deemed to have a forward facing orientation on the touch screen and relative to the user.

In addition, an object including more than three contact members may be provided and is usable with an application operable on the electronic device. This type of an object can be used for dynamic play with the electronic device.

Referring to FIGS. 11A-11D, exemplary embodiments of applications and objects that can be used therewith are illustrated. In FIG. 11A, an electronic device 4000 is generating a display 4010 simulating a parking lot from a simulated driving program. An object 4020, such as a toy vehicle 4020, can be used with the device 4000 to provide for interactive play. Similarly, in FIG. 11B, an electronic device 4100 generates a display 4110 simulating a city and an object 4120 resembling a toy airplane can be used with a flying program on the electronic device 4100. Also, in FIG. 11C, an electronic device 4200 generates a display 4210 resembling a wrestling ring and multiple objects 4220 and 4230 that are action figures resembling wrestlers can be used with the device 4200. In FIG. 11D, an electronic device 4300 generates a display 4310 resembling a construction site and an object 4320 configured as a toy construction vehicle can be used with the device 4300.

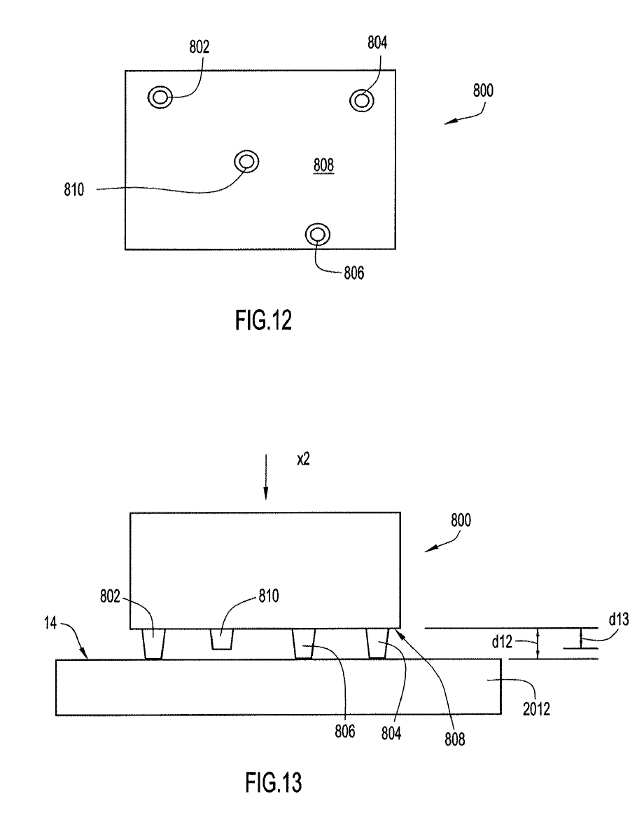

Referring to FIGS. 12 (bottom view) and 13 (side view), an object 800 includes a first contact member 802, a second contact member 804, and a third contact member 806 extending outwardly from an underside 808 of the object 800 by a distance d12. The object 800 also includes a fourth contact member 810 extending outwardly from the underside 808 by a distance d13 less than the distance d12. If the object 800 is placed on a touch screen 14 of an electronic device 12, the first, second and third contact members 802, 804, 806 engage the touch screen 14 (as shown in FIG. 13) and are thereby detected by the electronic device 12. A first output is generated by the electronic device 12 upon detection of the first, second and third contact members 802, 804, 806. The fourth contact member 810 engages the touch screen 14 and is detected by the electronic device 12 if the object 800 is pushed downwardly in direction X2 toward the touch screen 14. In one embodiment, this movement of contact member 810 into engagement with the touch screen 14 can occur if contact members 802, 804, and 806 are compressible. In another embodiment, contact member 810 can be movable relative to the body to which it is coupled. A second output different than the first output is generated by the electronic device 12 upon detection of the first, second, third and fourth contact members 802, 804, 806, 810.

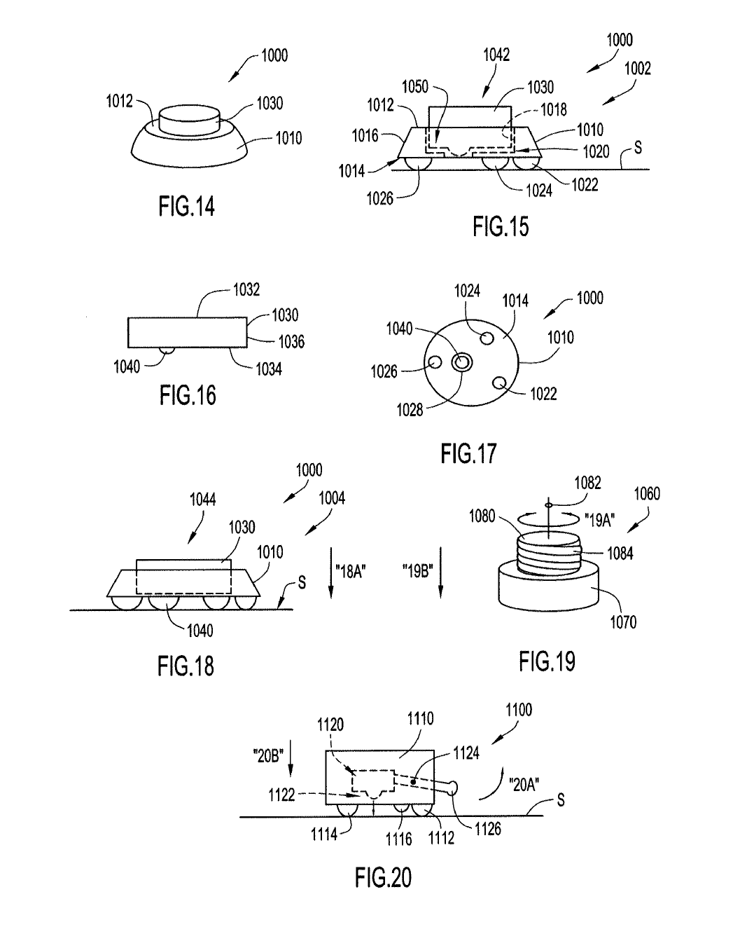

Another embodiment of an object that is useable with a touch screen in a selective manner is illustrated in FIGS. 14-18. The object 1000 is a dynamic device that includes a mechanical component. As described in detail below, the object 1000 includes an additional contact member that creates an additional contact point that results in an output that is in addition to simply the presence of a fixed object on a touch screen.

Referring to FIG. 14, a perspective view of the object 1000 is illustrated. While the outer perimeter of object 1000 in this embodiment is generally circular, in different embodiments, the shape of the perimeter of the object 1000 can vary and be a square, a rectangular, or other shape or configuration. In this embodiment, the object 1000 includes a base member 1010 and an input member 1030. The input member 1030 is movably coupled to and supported by the base member 1010 and can be manipulated in a manner similar to a switch. The object 1000 can be placed onto a touch screen of an electronic device. The input member 1030 can be moved or manipulated by a user to provide an additional contact or input to the touch screen in a selective manner.

Referring to FIGS. 15 and 16, side and bottom views of the object 1000 are illustrated. As shown, the base member 1010 has an upper surface 1012, a lower surface 1014, and a side surface 1016. The base member 1010 also includes an inner wall 1018 that defines a receptacle or channel 1020 in which the input member 1030 is located. As shown, the lower surface 1014 of the object 1000 has an opening 1040 that is in communication with the receptacle 1020 of the base member 1010.

Extending from the lower surface 1014 are several contact members 1022, 1024, and 1026. In one embodiment, the contact members 1022, 1024, and 1026 may be conductive so that capacitance from a person holding the object 1000 proximate to or in contact with the touch screen S results in a change in the charge of the screen at touch points, as part of the charge is transferred to the person holding the object. The base member 1010 can be made of or coated with a conductive material to transfer the touch of a human to the contact members 1022, 1024, and 1026. The contact members 1022, 1024, and 1026 generate touch or contact points on the touch screen which are used to identify the particular object. A first output or series of outputs can be generated by the electronic device in response to the detection of contact members 1022, 1024, and 1026. In a different embodiment, the contact members 1022, 1024, and 1026 are not conductive and are used only to support the object 1000 on the touch screen S.

Referring to FIG. 16, a side view of the input member 1030 is illustrated. In this embodiment, the input member 1030 includes an upper surface 1032 and a lower surface 1034. A protrusion or contact member 1040 extends from the lower surface 1034 as shown. In one embodiment, the input member 1030 can be made of a conductive material so that the capacitance of a touch screen S can be changed due to a person touching the input member 1030.

Referring to FIGS. 15 and 18, the use of the object 1000 is illustrated. In FIG. 15, the toy object 1000 is illustrated in a non-use configuration 1002 in which the input member 1030 does not engage the touch screen S. In this configuration 1002, the input member 1030 is in a raised or non-engaged position 1042 spaced apart from the touch screen S. In FIG. 18, the input member 1030 has been moved along the direction of arrow “18A” to its lowered or engaged position 1044 in which the contact member 1040 touches or is proximate to the touch screen S.

The input member 1030 may be retained to the base member 1010 and prevented from separating therefrom via a tab and slot arrangement or other mechanical mechanism. A biasing member, such as a spring 1050, can be located between the input member 1030 and the base member 1010 to bias the input member 1030 to its non-engaging position 1042. Since the input member 1030 is spring-loaded, the input member 1030 will be in only momentary contact with the touch screen.

A user can selectively move the input member 1030 repeated along the direction of arrow “18A” to make intermittent contact with the touch screen S. When the button is pressed, the addition contact point is created on the touch screen and feedback, such as a tactile feedback, can be generated and felt by the user. Some examples of objects may include levers, rotary knobs, joysticks, thumb-wheel inputs, etc. Alternatively, the intermittent contact can be used to input data into the electronic device in a serial manner.

In another embodiment, the input member 1030 and base member 1010 may be a two part conductive plastic item with a spring detent, such that when a user holds the object 1000 to the screen of the device, the input device or object types is detected, and the button or input member 1030 can be pressed.

In one exemplary implementation, the toy object can be a simulated blasting device with a switch. The base member of the toy object can be a housing and the input member 1030 can be a movable plunger, the movement of which into engagement with the touch screen results in an output on the electronic device that is audible, visible, and/or tactile.

In various embodiments, the actuation and movement of the input member of a toy object can vary. In addition to the pressing motion described above, the input member can be rotated, twisting, rolled, slid, and/or pivoted relative to the base member.

Referring to FIG. 19, in this embodiment, the base member 1070 has an input member 1080 movably coupled thereto. The input member 1080 can be screwed into and out of an opening in the base member 1070. The input member 1080 has a thread 1084 located on its outer surface and can be rotated in either direction of arrow “19A” about axis 1082. When the input member 1080 is rotated sufficiently so that the input member is moved along the direction of arrow “19B,” a contact member located on the lower surface of input member 1080 engages the touch screen of an electronic device on which the object is placed.

Referring to FIG. 20, in this embodiment, the object 1100 includes a base member 1110 with several contact members 1112, 1114, and 1116 that can engage a touch screen S, as previously described. The object 1100 includes an input member 1120 located within a receptacle or chamber in the base member 1110. The input member 1120 has a main body with a contact member 1122 extending therefrom. A lever arm 1126 is pivotally mounted at pivot point 1124 to the base member 1110 so that movement of lever arm 1126 along the direction of arrow “20A” results in movement of the body 1120 along the direction of arrow “20B” so that contact member 1122 engages the touch screen S. To disengage contact member 1122 from the touch screen S, the lever arm 1126 is moved in the opposite direction. In a variation of this embodiment, the lever arm can be replaced with an arm that is pressed or slid downwardly to move the input member in the same direction.

In another embodiment, the object includes two or more contact members, as well as data stored in an associated memory. Upon depression of the object against the touch screen, the data is transmitted from the object to the electronic device. For example, a user's contact information may be transmitted to the electronic device upon depression or activation of the object. The object may be configured such that different or additional data is transmitted upon subsequent depressions or activations. For example, an address of the user may be transmitted upon an initial depression or engagement of the object against the touch screen of an electronic device. The user's business profile (e.g., employment history, technical skills, etc.) may then be transmitted from the object to the electronic device upon a subsequent depression or engagement between the object and the touch screen.

In another embodiment, the object, once properly identified by an application, may ‘unlock’ a database accessible to the electronic device, which may include information relating to the object. For example, collector dolls may be provided with contact members that can be used with an electronic device to identify the object. Upon engagement with the touch screen by the contact members, information relating to collector type data is presented to the user.

Thus, the recognized pattern of contact points may be used by an application running on the electronic device to identify the particular conductive object and/or to provide specific information related to the object or user. Various applications may be run on the electronic device that use the contact and identification of the conductive object as an input. For example, a game application can look for a particular object to be used with the screen at a particular point in the game. If the correct object is placed on the screen, then a feature or portion of the game can be unlocked and/or a particular output may be generated and displayed.

The electronic device and associated application are configured to generate an output specific to a recognized pattern of contact points on the touch screen, as well as in response to movement of the recognized pattern of contact points on the touch screen. The pattern of contact points defines an identification that is associated with a particular object. An output specific to the associated object is then generated and displayed on the touch screen. The particular output generated and displayed may vary depending on the various patterns of engagement points associated with the corresponding various objects, as well as on the particular application operable by the device.

In different implementations, the conductive devices or objects can be hard or soft. Further, the particular types and locations of touches or contact points on the touch screen can vary, as well as the content that is unlocked or accessed. Thus, various embodiments of the present invention are possible.

The quantity of contact points that can be detected by an application is determined in part by the particular electronic device running the application.

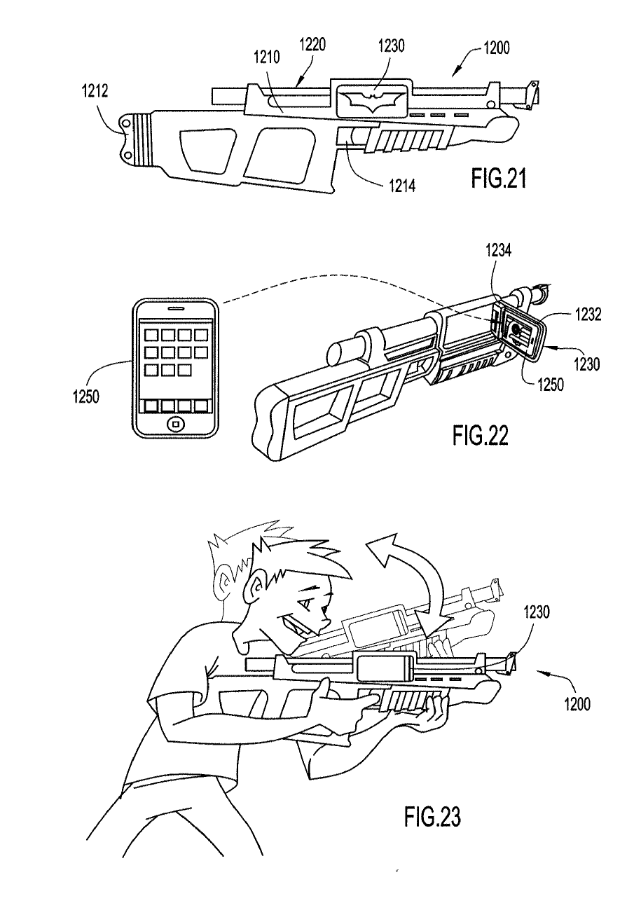

Another exemplary embodiment of the invention is illustrated in FIGS. 21-23. In this embodiment, a simulated toy weapon 1200, such as a rifle, includes a barrel portion 1210, a support portion 1212, and a trigger 1214 that can be manually actuated. The toy weapon 1200 includes an electronic system with several light emitting elements 1220 and a transducer for generating audible outputs. When a child plays with the toy weapon 1200, lights and/or sounds are generated in response to interaction by the child with the toy weapon 1200.

The toy weapon 1200 can be used with an electronic device 1250 (shown in FIG. 22). The toy weapon 1200 includes a repositionable, interactive portion 1230 that includes a door or plate 1232 that is pivotally coupled to the barrel 1210 at its end 1234 by a coupler or hinge. Portion 1230 can be flipped outwardly to couple the device 1250 to the toy weapon 1200. The inner surface of the plate 1232 includes a receptacle into which the device 1250 can be inserted or snapped into place so that the device 1250 is physically retained by the physical toy (the toy weapon 1200). As a result, the screen 1252 of the device 1250 becomes part of the physical toy. In another embodiment, the plate 1232 can be slidably coupled to the toy weapon 1200. When the repositionable portion 1230 is flipped outwardly, the screen 1252 remains viewable for the child while playing with the toy weapon 1200, thereby enhancing the play experience. At the same time, the toy weapon 1200 retains independent play value even when the electronic device 1250 is not attached to the toy. For example, it might include lights and sounds that can be actuated even in the absence of electronic device 1250.

The toy weapon 1200 can recognize the presence of the device 1250 through detection via a switch and the device 1250 can recognize the toy weapon 1200 through its touch screen 1252. In one embodiment, a portion of the toy weapon 1200, such as a portion near hinge 1234, can engage the touch screen 1252 of the device 1250 in a manner that enables an application running on the device 1250 to identify the toy weapon 1200 to which the device 1250 is coupled. For example, the application may create a special area or region in which a part of the toy weapon 1200, such as a conductive portion, may engage the touch screen 1252. The single touch point created by the toy weapon 1200 is used for identification of the toy weapon 1200. The single touch point may be created when the user touches the toy as long as the capacitance of the user can travel and pass to the touch screen 1252 of the device 1250.

In one implementation, when the electronic device 1250 is coupled to the toy weapon 1200, the device 1250 can sense or detect when a child first picks up the weapon 1200 through the touch of the child on the weapon 1200. When a child picks up the weapon 1200, the touch of the child provides the capacitance needed by the touch screen of the electronic device 1250 to cause an application running thereon to generate an audible and/or visible output. At least a part of the weapon 1200 may be made of a conductive material or a non-conductive material with a conductive coating or plating thereon. Thus, when a child first picks up the weapon 1200, the device 1250, either alone or via the weapon 1200, can generate an output that is interesting to the child to cause the child to play with the weapon 1200.

The toy weapon 1200 may also recognize the presence of the device 1250 as provided below in paragraph [00127]. In particular, a portion of the screen of device 1250 may blink in a recognizable pattern that may be detected by a detector included in toy weapon 1200. For example, a portion of door plate end 1234 might include a photodetector that can recognize the presence or absence of light (or light at certain wavelengths) emitted from a target portion of the screen of device 1250. Device 1250 may use this capability to transmit data, including a signature indicating not only that device 1250 is installed in toy 1200, but that the proper application is running on device 1250.

When the device 1250 determines that it is mounted or coupled to the toy weapon 1200, the application running on the device 1250 can enter into a different portion of the program or application. For example, the toy weapon 1200 by itself can be manipulated to make audible and/or visible outputs, such as by the actuation of the trigger 1214 or the movement of the toy weapon 1200. The application on the device 1250 can enhance the outputs from the toy weapon 1200 by generating audible and/or visible outputs as well in response to any interaction of the child with the toy weapon 1200. The application on the device 1250 can use the output components (the electronic system including the transducer) of the toy weapon 1200 as a pass-through for the outputs generated from the device 1250. In other words, the outputs generated by the device 1250 can be played through the output components of the toy weapon 1200, which can amplify the outputs of the device 1250.

In one implementation, the generation of outputs by the device 1250 and toy weapon 1200 can occur in response to a particular input from the user of the toy weapon 1200. The device 1250 may wait for a second contact point to be detected by the touch screen 1252 before any outputs are generated. The second contact point may be generated in response to the child's activation of the trigger of the toy weapon 1200. When a child pulls the trigger, a second touch point in a special region of the touch screen 1252 can be generated. In response to this second touch point, the electronic device 1250 can generate a particular output, such as the sound of a weapon shooting. This second touch point can be generated by a mechanical link or linkage coupled to the trigger that moves into contact with the touch screen 1252 as the trigger is pulled. Alternatively, this second touch point can be generated by a wire or cable that is movable in response to the movement of the trigger of the toy weapon 1200. The wire or cable touches the touch screen 1252 when the trigger is pulled. This second touch or contact point provides for focused outputs that are directed associated with the interaction of the child with the toy weapon 1200. In yet another alternative, the second touch point may already be in contact with the screen 1252, but might not be capacitively coupled to the child's body until the child pulls the trigger. For example, the pulling of a trigger may close a switch that electrically connects the second touch point to the child's finger.

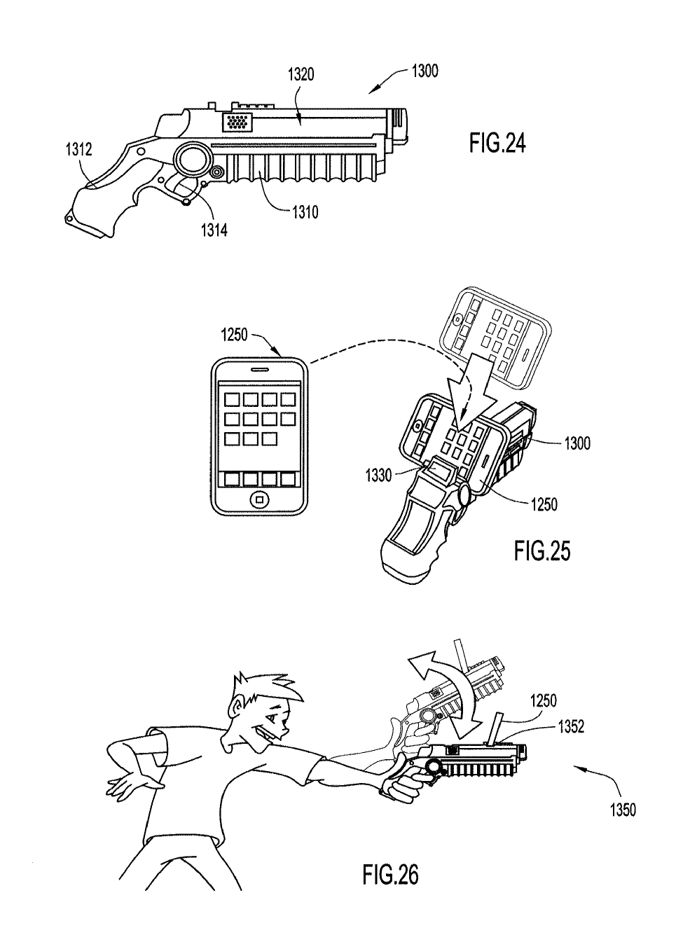

Referring to FIGS. 24-26, additional embodiments of a toy weapon useable with an electronic device are illustrated. Referring to FIG. 24, the toy weapon 1300 includes a barrel portion 1310, a handle 1312, and a trigger 1314. A light output device 1320 is coupled to the barrel portion 1310. Similar to toy weapon 1200, the toy weapon 1300 can generate audible and/or visible outputs.

Referring to FIG. 25, toy weapon 1300 includes a mounting mechanism 1330 that is configured to receive a portion of the electronic device 1250 to couple the device 1250 to the toy weapon 1300. The mounting mechanism 1330 is located near the intersection of the handle portion and barrel portion of the weapon 1300. The mobile electronic device 1250 can be slid into the mounting mechanism 1330 which includes a slot to receive the device 1250. In one embodiment, an application for an on screen game is opened when the electronic device 1250 is mounted to the toy weapon 1300. When the device 1250 is mounted, the device 1250 can interact with the toy weapon 1300, which detects the presence of the device 1250 through mounting mechanism 1330.

Referring to FIG. 26, a toy weapon 1350 is illustrated that is generally similar in configuration to toy weapon 1300 with the exception that the location of its mounting mechanism 1352 is located along the barrel portion of the toy weapon 1350.

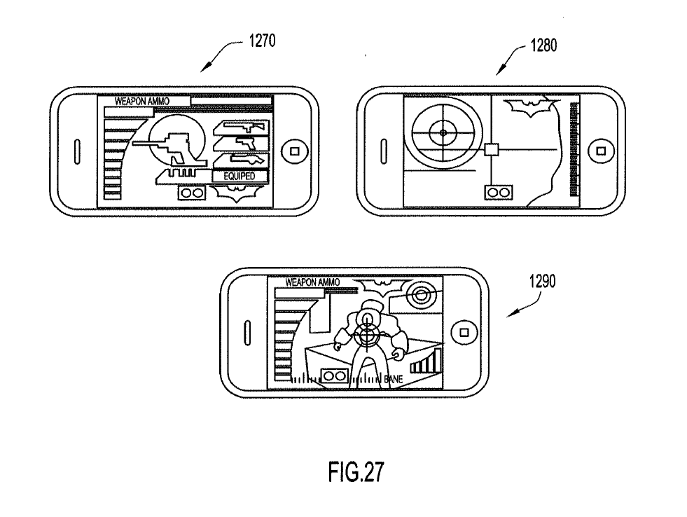

Some exemplary applications that can be run on the electronic device 1250 while coupled to the toy weapons 1200 and 1300 are illustrated in FIG. 27. Screen shot 1270 is part of a change weapon mode of play in the application in which the child can change the particular weapon that the toy weapon 1200 simulates via various outputs. Screen shot 1280 is part of a night vision play in the application. Screen shot 1290 shows an augmented reality game that can be playing on the device 1250 while the child plays with and maneuvers the toy weapon 1200.

The touch screen 1252 of the electronic device 1250 can be used for both input and output. Input via the screen can be accomplished as described above through the use of one or more contact members creating one or more contact points, and thus, the toy weapons 1200 and 1300 can control the device 1250 by the points. The screen can also output data and information to the toy weapons 1200 and 1300 by blinking an image or lights (or lights of particular wavelengths) that can be sensed by a detector associated with and/or forming part of the toy weapons 1200 and 1300. Such data could include a signature indicating the running of a particular application, or it might include data used by the toy to enhance gameplay.

In other embodiments of the invention, an interactive toy different than the toy weapons 1200 and 1300 can be can be used with an electronic device 1250 which enhances the play and use of the interactive toy.

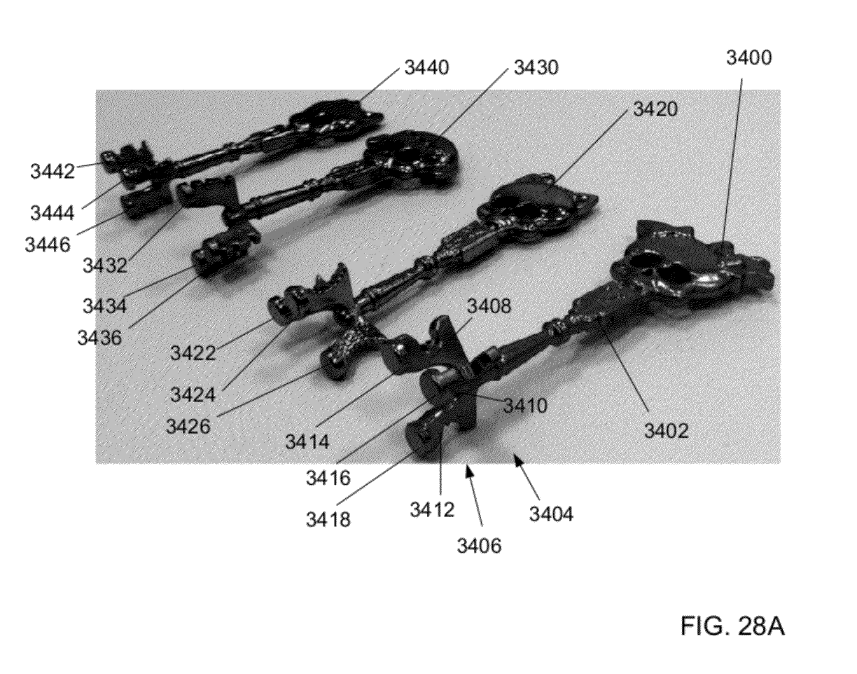

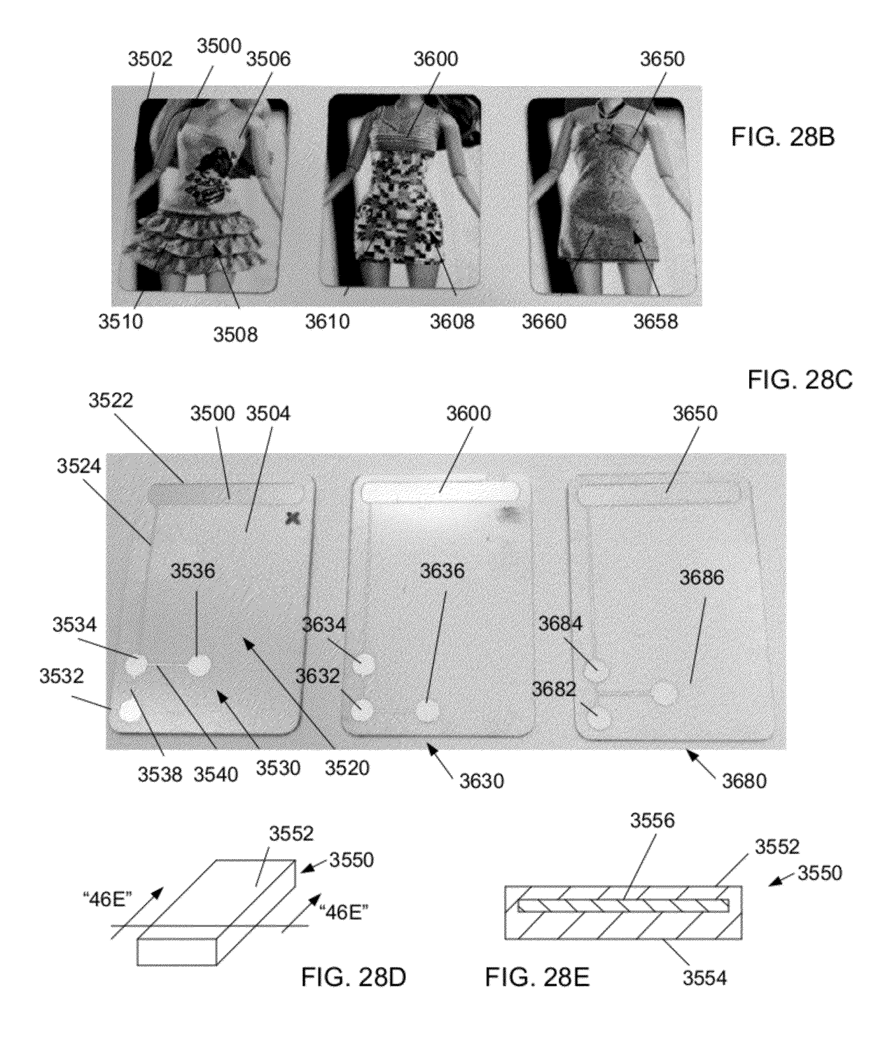

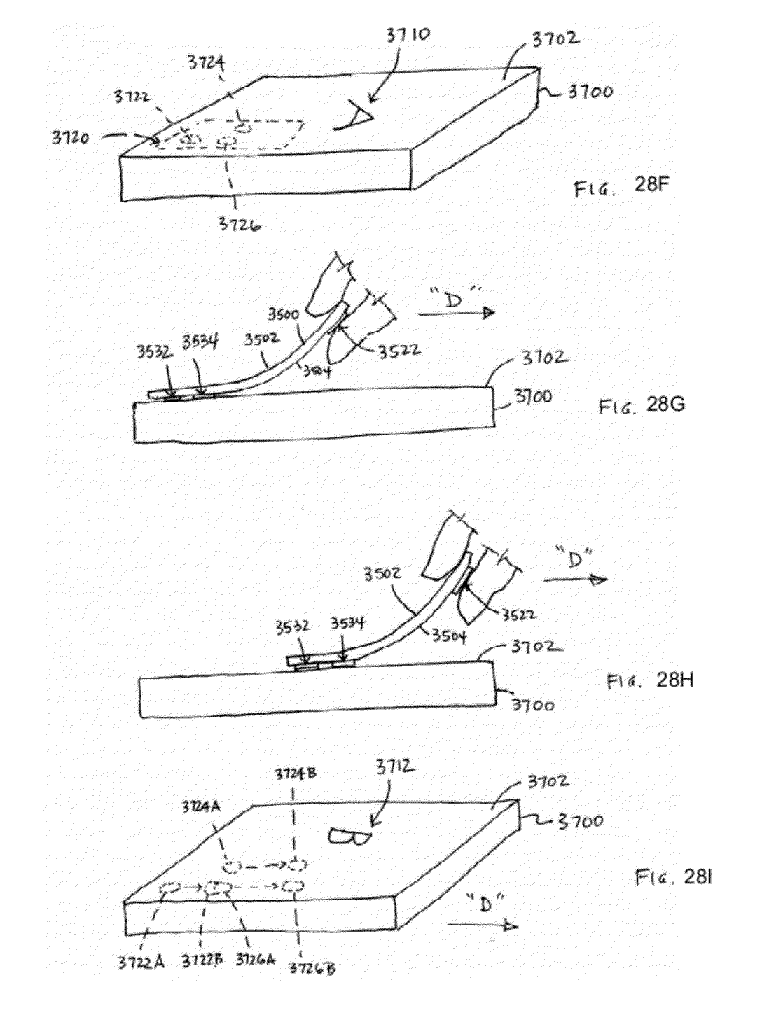

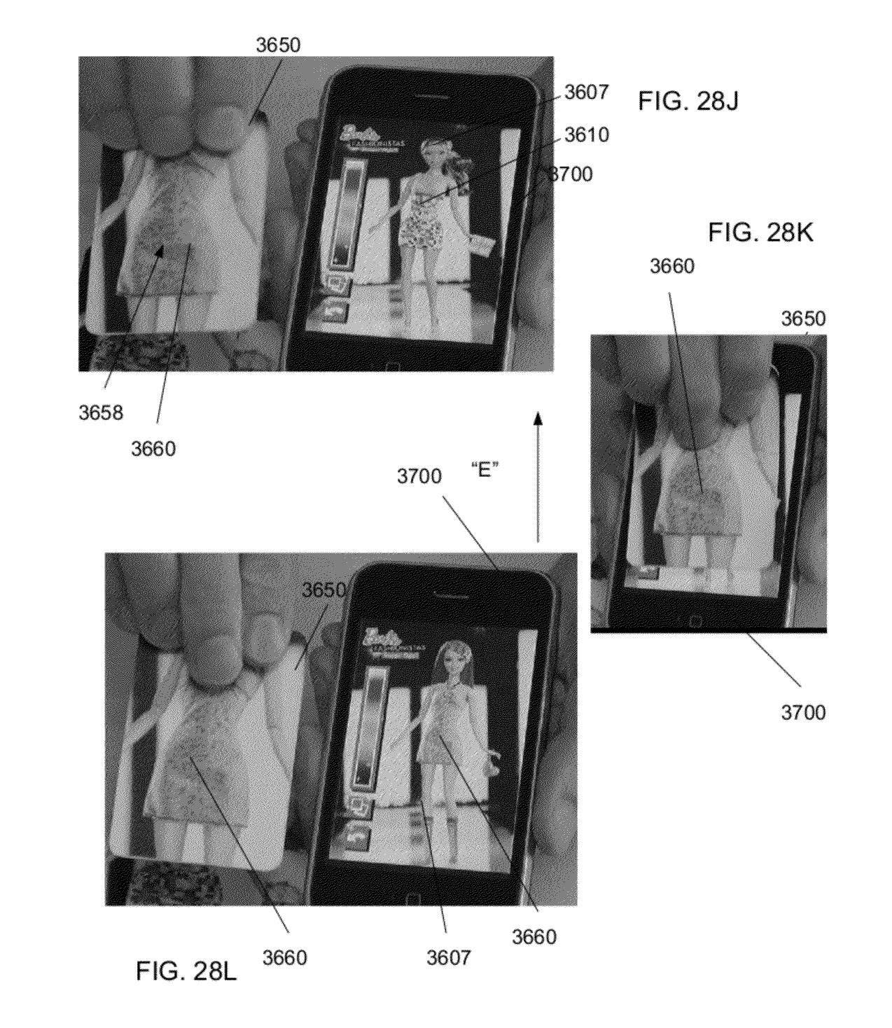

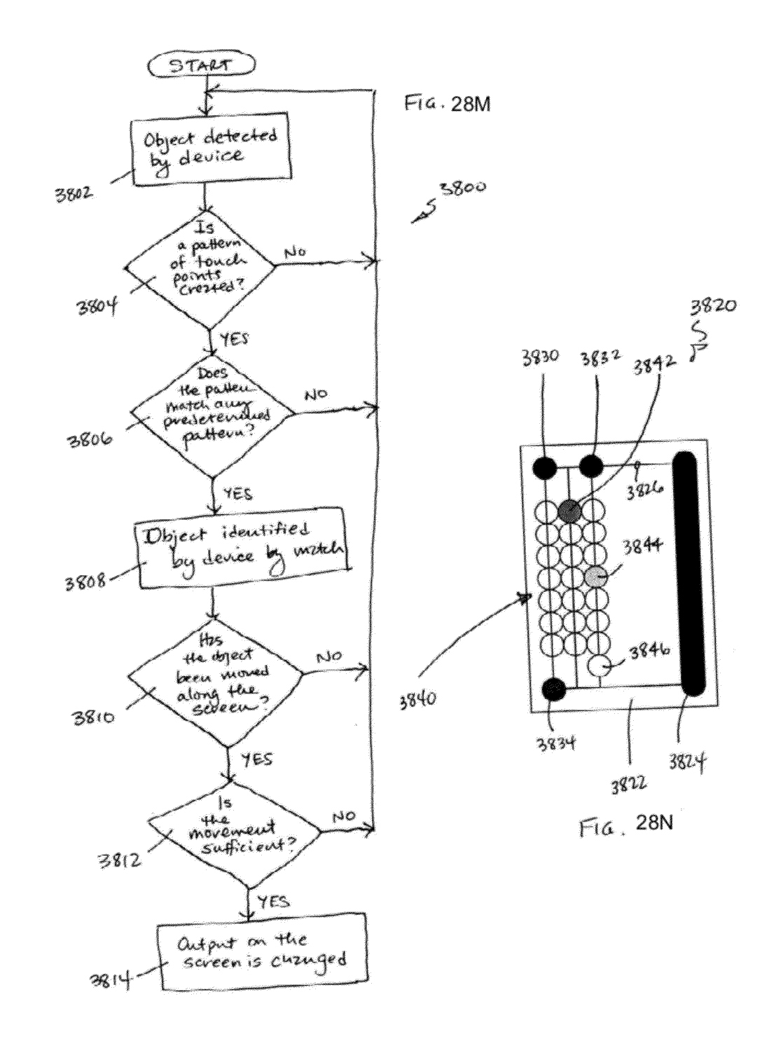

Additional embodiments of objects usable with the disclosed systems are illustrated in FIG. 28A. Referring to FIG. 28A, the objects 3400, 3420, 3430, and 3440 are configured to resemble keys. While key 2300 illustrated in FIG. 24 had two contact members, each of the keys 3400, 3420, 3430, and 3440 has three contact members.

Key 3400 includes a handle portion 3402 and an opposing end portion 3404 with an identification section or portion 3406. In this embodiment, the identification section 3406 has spaced projections 3408, 3410, and 3412 that have contact members 3414, 3416, and 3418, respectively. The key 3400 includes a conductive coating covering the key 3400 and defining the outer surface thereof. When a user holds the key 3400, the capacitance of the user's body is transferred through the conductive outer coating on the key 3300 to the contact members 3414, 3416, and 3418, which changes the capacitance on the touch screen of an electronic device which recognizes the transferred capacitance and can be detected as three touch points. The spacing between the contact members 3414, 3416, and 3418 is in a pattern that is unique to key 3400.

Keys 3420, 3430, and 3440 have a similar coating and corresponding projections with contact members 3422, 3424, 3426, contact members 3432, 3434, 3436, and contact members 3443, 3444, and 3446, respectively, as illustrated. The pattern of touch points that are formed by contact members 3422, 3424, and 3426 is different than the points formed by keys 3400, 3430, and 3440. Similarly, contact members 3432, 3434, and 3436 define a pattern unique to key 3430 and contact members 3442, 3444, and 3446 define a pattern unique to key 3440.

The unique patterns of each of the keys 3400, 3420, 3430, and 3440 enable each of the keys to be identified by an application running on an electronic device as described herein. In one exemplary mode of play, multiple users can engage multiple ones of keys 3400, 3420, 3430, and 3440 simultaneously with a touch screen of an electronic device. The electronic device may be running an application that is a game that requires more than one of the keys to be engaged with objects on the touch screen. For example, images of four keyholes similar to keyhole 2402 described above can be displayed at different locations on the touch screen. Each of the keyholes has a specific pattern, which corresponds to the patterns of touch points generated by the contact members of the keys 3400, 3420, 3430, and 3440. In one game, the users must align each key with its corresponding keyhole and turn the keys 3400, 3420, 3430, and 3440 while in contact with the touch screen to provide the required input to unlock content in the application. The keys 3400, 3420, 3430, and 3440 may be placed into contact with the touch screen one after another in succession. Depending on the particular electronic device, multiple keys may be detected simultaneously based on the quantity of touches created by each of the keys. For example, the current version of the iPad® can detect up to eleven simultaneous touches while the current version of the iPhone® can detect up to five simultaneous touches. Thus, one key having three contact members can be used at a time with the iPhone and three keys having three contact members each can be used simultaneously with the iPad.

Additional embodiments of objects that can be used with an electronic device according to the present invention are illustrated in FIGS. 28B-28L. Referring to FIG. 28B, a top view of objects 3500, 3600, and 3650 are shown. Each of the objects 3500, 3600, and 3650 has a card-shaped configuration. In other words, object 3500 is generally rectangular and thin with opposite sides or surfaces 3502 and 3504 (see FIG. 28C) and an outer edge 3506 that defines a perimeter. Objects 3600 and 3650 have similar configurations to object 3500. In one embodiment, the objects 3500, 3600, 3650 are made of paper or plastic and are flexible and bendable. The term “flexible” is intended to include any object that can be bent, conformed, or reconfigured in any way, whether soft or hard. In an alternative embodiment, the objects can be pieces of fabric

Object 3500 includes an image 3508 on side 3502 that resembles a piece of apparel 3510. The image 3508 can be printed onto side 3502 of the object 3500. In one implementation, the piece of apparel 3510 is representative of a dress that can be worn a doll that is displayed on the touch screen of the electronic device. Objects 3600 and 3650 have images 3608 and 3658 that resemble different pieces of apparel 3610 and 3660 as well.

In an exemplary use (described in greater detail below), an electronic device runs an application that displays a virtual object that resembles a doll. The virtual doll has a particular style or appearance based on the clothing displayed with the doll on the screen. A child playing with the application can change the appearance of the virtual doll on the screen using one of the objects 3500, 3600, or 3650 as each of the objects is associated with a different virtual clothing. For example, the child can change the doll so that the doll appears to be wearing the clothing 3510 illustrated in image 3508 by using object 3500 with the electronic device. In addition, the child can change the appearance of the virtual doll so that the doll is wearing the clothing 3610 or 3660 in images 3608 or 3658 by using the corresponding one of the objects 3600 or 3650 with the electronic device. In different embodiments, the images on the cards or objects 3500, 3600, and 3650 can be associated with different items other than apparel or clothing for a doll. Such images may be directed to accessories for figures or characters.

For the objects 3500, 3600, and 3650 to be useable with an electronic device, each of the objects 3500, 3600, and 3650 is configured to create contact or engagement or touch points on the electronic device that can be detected. An application on the electronic device has a table or database of the identities of different objects (such as objects 3500, 3600, and 3650) that can be used with the program. Each of the objects 3500, 3600, and 3650 can be used as an input to the application at an appropriate point in the program. The application is operable to detect the presence of one of the objects 3500, 3600, and 3650 proximate to the touch screen of the electronic device. In addition, the application determines the identity of the object that is present or proximate to the touch screen based on the detected touch points.

Thus, each of the objects 3500, 3600, and 3650 includes an identification system or identification characteristic that can be detected by an electronic device. Referring to FIG. 28C, card 3500 includes an identification system 3520 that is useable with a capacitive touch screen for detection by the electronic device to identify object 3500 when object 3500 is proximate to or in contact with the electronic device.

In this embodiment, the identification system 3520 includes a contact portion 3522 and an identification portion 3530 connected to the contact portion 3522 via a trace 3524. The identification portion 3530 includes contacts or contact members 3532, 3534, and 3536 that are connected to each other by traces 3538 and 3540.

Each of the contact portion 3522, the contacts 3532, 3534, 3536, and the traces 3538, 3540, and 3524 is conductive, which enables the charge from a human touching contact portion 3522 to be transferred via the traces to the contacts 3532, 3534, and 3536. In one implementation, the conductive members are formed of metal and coupled to the object 3500 using an adhesive, bonding, or other coupling technique. In another implementation, the conductive members are formed by printing a conductive film or ink onto a surface of the object 3500. The contacts 3532, 3534, and 3536 are spaced apart and separated by predetermined distances that are unique to the object 3500. The relative distances between the touch points generated by the contacts 3532, 3534, and 3536 are determined by the sensor of the electronic device and checked against predetermined sets of touch points that are expected by the application.

Referring to FIG. 28C, objects 3600 and 3650 include identification systems 3630 and 3680 with contacts 3632, 3634, and 3636 or contacts 3682, 3684, and 3686, respectively. Contacts 3632, 3634, and 3636 are located on object 3600 in a predetermined spaced apart relationship. A pattern of touch points on the screen of the electronic device are generated in response to contacts 3632, 3634, and 3636 being proximate to or in engagement with the touch screen. Each of the contacts and contact portions of the objects 3600 and 3650 are conductive, similar to the components of object 3500.

Returning to object 3500, all of the components of the identification system 3520 are located on the same side of the object 3500. As illustrated, the identification system 3520 is located on the side 3504 that is opposite to the side 3502 on which image 3508 is located. When a user holds object 3500 proximate to a touch screen (as shown in FIGS. 28G, 28H, and 28K), the identification system 3520 is located adjacent to the touch screen while the image 3508 on the other side of the object 3500 is visible to the user. Thus, the user can confirm that the desired object is being used with the touch screen by seeing the image on the object while manipulating the object relative to the touch screen.

Referring to FIGS. 28D and 28E, another embodiment of an object according to the present invention is illustrated. An object 3550, such as a card, has a first surface 3552 and a second surface 3554 opposite to surface 3552. The object 3550 includes an identification system that has a contact portion 3556 (shown in cross-section in FIG. 28E) and several internal contacts (not shown). In this embodiment, the identification system is located inside of the card in an interior region or area and not on surface 3552 or surface 3554. Object 3550 can be used with a capacitive touch screen in the same manner as objects 3500, 3600, and 3650 discussed above as the thickness of object 3550 is small enough that the identification system can be detected by the electronic device even thought it is not engaged directly with the touch screen.

Referring to FIGS. 28F-28I, an exemplary use of object 3500 with an electronic device 3700 is illustrated. The electronic device 3700 has a touch screen 3702 that displays an image 3710, which is represented as “A.” In different embodiments, the image 3710 can be one or more of an article, a toy, a figure, a character, a toy vehicle, or other structure. For example, the image 3710 can be a figure and the figure can be a static image or part of an active game.

In one embodiment, the touch screen 3702 has a detection region 3720, shown in phantom lines. The detection region 3720 is a portion of the touch screen 3702 in which touch points (such as those formed by contact points 3722, 3724, and 3726) are expected by the application operating on the electronic device 3700. In another embodiment, the detection region 3720 can be much larger and can encompass any location on the screen. The contact points 3722, 3724, and 3726 are exemplary of touch points created by conductive contact members on an object, such as a card, that is proximate to the touch screen 3702.

Referring to FIG. 28G, a side view of the card 3500 engaged with the electronic device 3700 is illustrated. Side 3502 is oriented away from the touch screen 3702 and side 3504 is proximate to the touch screen 3702. In the illustrated position, the card 3500 is placed so that its identification portion is proximate to the touch screen 3702. As discussed above, the identification portion includes contact members (only members 3532 and 3534 are shown), which create touch points 3722 and 3726, respectively. When the user touches the contact portion 3522, the capacitance of the user is transferred to the contact member 3532 and 3534 via traces (not shown in FIG. 28G) and thus, to the touch screen 3702, thereby creating touch points 3722 and 3726. As discussed above, touch points generated on a capacitive screen are used to identify the particular object with the contact members forming the touch points. The system determines the distances between touch points and identifies the particular object that is associated with those distances. The system may make its identification while the card 3500 or object is stationary. Alternatively, the card 3500 or object may be identified while the contact members 3532, 3534 are translated or “swiped” across the touch screen 3702.

As the user swipes or slides the card 3500 along the touch screen 3702 along the direction of arrow “D,” the card 3500 moves to its position illustrated in FIG. 28H. The movement of the card 3500 along arrow “D” is detected by the control system of the electronic device and is illustrated in FIG. 28I as the contact points moving during the swipe or slide. As shown, contact 3724 moves from point 3724A to point 3724B, contact 3722 moves from point 3722A to point 3722B, and contact 3726 moves from point 3726A to point 3726B. The action of swiping the card 3500 may be beneficial by providing the system with a sequence of redundant reads, which may be averaged to create a more robust identification. The averaging of redundant reads may be beneficial when the identification grid is small or on the edge of a device's positional jitter signal-to-noise threshold. The movement of the touch points is detected by the system and when such movement is detected, the application changes the output 3712 on the display screen, which is illustrated as “B” and which is different than output 3710. For example, the card 3500 is associated with clothing and output 3712 is the figure shown in output 3710 wearing the clothing. In another example, the card 3500 is associated with a weapon, such as a gun, and output 3712 is the figure shown in output 3710 holding or using the weapon. A card is associated with an object or item in the application on the electronic device in that when a card is detected, a specific output (relating to an object or item) has been programmed to be generated in response to the particular detection.

In one embodiment, the output 3712 is depicted, at least in part, on card 3500, which was swiped by a user to change output 3710 to output 3712 on the screen 3702. In addition, the electronic device 3700 may generate an audible output upon the detection of the start of a swipe or upon the completion of a swipe of the card. The audible output can be music, sound effects, and/or speech.

Referring to FIGS. 28J-28L, another exemplary use of an input object with an electronic device is illustrated. In this implementation, the electronic device 3700 has a touch screen and the application operating on the device 3700 is displaying a virtual image of a doll 3607. The virtual doll 3607 has apparel 3610 that it is wearing in the image. Also illustrated in FIG. 28J is another card 3650 that has the image 3658 of a piece of apparel 3660, which is different than the apparel 3610 currently displayed on the doll 3607 on the screen.

Referring to FIG. 28K, the user places the card 3650 proximate to the touch screen of the device 3700. The card 3650 can be in contact with the touch screen or proximate to the touch screen and not in contact as the capacitive touch screen of the electronic device 3700 can sense a change in capacitance even with a space between the card 3650 and the touch screen. The user moves the card 3650 along the direction of arrow “E” relative to the screen.

When the control system of the electronic device 3700 detects the touch points created by the contact members on card 3650, the pattern of touch points is compared to expected patterns of touch points by the program. If the pattern of touch points is matched, the card 3650 is identified by the match. The application then awaits the movement of the points along the direction of arrow “E.” In response to a required movement of the card 3650, the appearance of the virtual doll 3607 changes to correspond to the moved card 3650. As shown in FIG. 28L, once the card 3650 has moved along the touch screen, the application changes the display on the screen so that the virtual doll 3607 has clothing 3660 that corresponds to the clothing 3660 depicted on the card 3650. Other cards with different images can be used to change the appearance of the doll displayed on the touch screen.

An exemplary process is illustrated via the flowchart 3800 in FIG. 28M. The process begins with an object detected by the device 3700 in step 3802. If the device 3700 has a capacitive touch screen, the presence of the object is detected by a change in capacitance. The device 3700 determines whether a pattern of touch points are created on the screen in step 3804. If so, in step 3806, the device 3700 determines whether the pattern matches any predetermined pattern of touch points, which are associated with different objects. If a match is confirmed, the object can be identified by the device in step 3808. The control system of the device 3700 then determines whether the touch points move relative to the screen in step 3810, which is indicative of a swipe of the object. If the touch points have moved, the system determines in step 3812 whether the length of movement is sufficient, such as being at least a predetermined distance. A predetermined distance requirement ensures that the movement detected by the device is a swipe of the object, such as a card. If the swipe meets the required distance, the application changes the output that is displayed on the screen of the device in step 3814.

Referring to FIG. 28N, a schematic diagram of an identifiable object, such as a card, according to the present invention is illustrated. The card 3820 has an outer surface on which a contact member 3824 is located. While contact members for cards 3500, 3600, and 3650 were located along a shorter side of the cards, contact member 3824 is located along a longer side of the card. The card 3820 includes three fixed reference points 3830, 3832, and 3834 that are located in a spaced relationship that identifies the card as belong to a particular set or group of cards. A set 3840 of locations where variable ID points used to identify the particular card uniquely can be presented is illustrated. The locations are exemplary of the different positions where ID points may appear on different cards. In this embodiment, card 3820 includes contact members or ID points 3842, 3844, and 3846, which uniquely identify the card 3820. Points 3830, 3832, 3834, 3842, 3844, and 3846 are connected to each other and to the contact member 3824 via conductive traces 3826. In different embodiments, the locations and quantity of fixed reference points and the locations and quantity of ID points on a particular card can vary such that the card can be uniquely identified.

In an alternative embodiment of the invention, a card or card-shaped object can be used with the touch screen in a non-swiping or non-moving manner. The card isolates the user's fingers from the touch screen and the user's capacitive load is spread through traces on the card to multiple touch points on the lower surface of the card. The card can be placed on a touch screen and not moved. Once the card is placed on the touch screen, the user can touch the card to provide an input to the electronic device via the touch points on the card.

In some embodiments, the object may be a thin, flexible object molded into a slightly bowed shape. The user may apply pressure to the object at particular locations on the bowed shape so that the object lies flat against the touch screen. The particular locations may include touch points connected to contact members for transferring the user's capacitance to the touch screen. In some embodiments, the object may be an object with sufficient thickness to isolate a user's finger capacitance from the touch screen. Traces or other conductive material formations may transfer the capacitance from a user's touch from the surface of the object to the touch screen. In some embodiments, the objects may be co-molded, insert-molded, or laminated such that the conductive portions of the object are invisible to the casual observer's eye or otherwise not readily apparent.

In another embodiment of the invention, a card has touch points or contact members located on its lower surface connected to each other by conductive traces. The card can be placed on a screen of an electronic device. The card can have a location (such as the center of the card) that the user contacts to input the user's capacitive load through the traces and the touch points. In one implementation, the card includes indicia designating the particular location on the card to be touched by the user. The pattern of contact members forms touch points on the touch screen in a pattern that can be identified by the electronic device. Since the card is not moved, the entire lower surface area of the card is available for contact members, thereby increasing the quantity of identifications that are possible for the cards. Alternatives to a card are flowers, garments, badges, emblems, military stripes, patches, weapons, figure silhouettes, and accessories.

In another embodiment of the invention, the card is a programmable card that a user can swipe or move along a touch screen. Such a card has a main portion and a rotating portion that can be adjusted or moved by a user to change the ID pattern of contact members, based on the position of the rotating portion, in predetermined ways.

In another embodiment of the invention, the identification object is a piece of fabric that has conductive patterns printed on it. Alternatively, the fabric has a conductive thread sewn into in a pattern forming contact members.

In another embodiment of the invention, a mask or a representation of a face of a character, such as a human, animal, or other figure, can be printed onto a substrate. The substrate can be paper or a piece of plastic. The substrate has a front side and a back side with ID traces and contact points printed on the back side and facial characteristics located on the front side. The substrate can have a repositionable adhesive on the back side. When a child places the mask onto an electronic device, the touch points are aligned with areas along the edge of the screen. When the child touches the mask, the device can identify the mask and fill the face with proper graphics of certain facial features. The electronic device can receive inputs from a camera or a microphone to see or hear the child and then respond accordingly via the graphic character on the screen of the device.

In another embodiment, a shell or case can be molded from silicone. The shell can include a character shape and/or color(s). A pattern of conductive contact members is embedded in the shell, thereby enabling the shell to be identified by an electronic device. Once the shell is identified, the device can modify the user interface appropriately. One or more touch points on the case can be used as additional trigger points.

In another embodiment, an identifiable object can be a simulated credit or debit card. Such a card has a pattern of contact members defining an identification formed along a portion of the card, such as an edge. The card can include indicia that resembles a real credit card or debit card. The card can be swiped along the touch screen of the device. In one mode of play, the electronic device can operate an program that is a fashion-play application. The play pattern includes a child selecting to purchase a garment and the device displaying a graphic of a payment machine. The child slides or swipes the card along the payment machine graphic. The application presents a display screen that is typical of a point-of-sale display and then a signature screen. The application can periodically send fake card statements to an account, such as an email account.

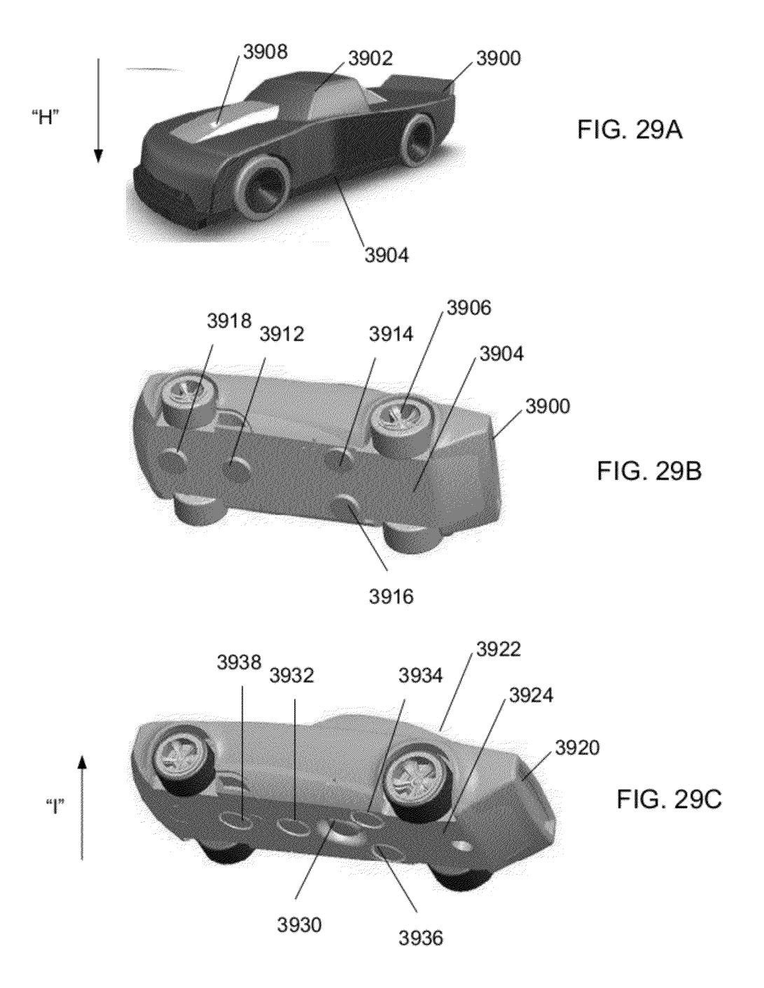

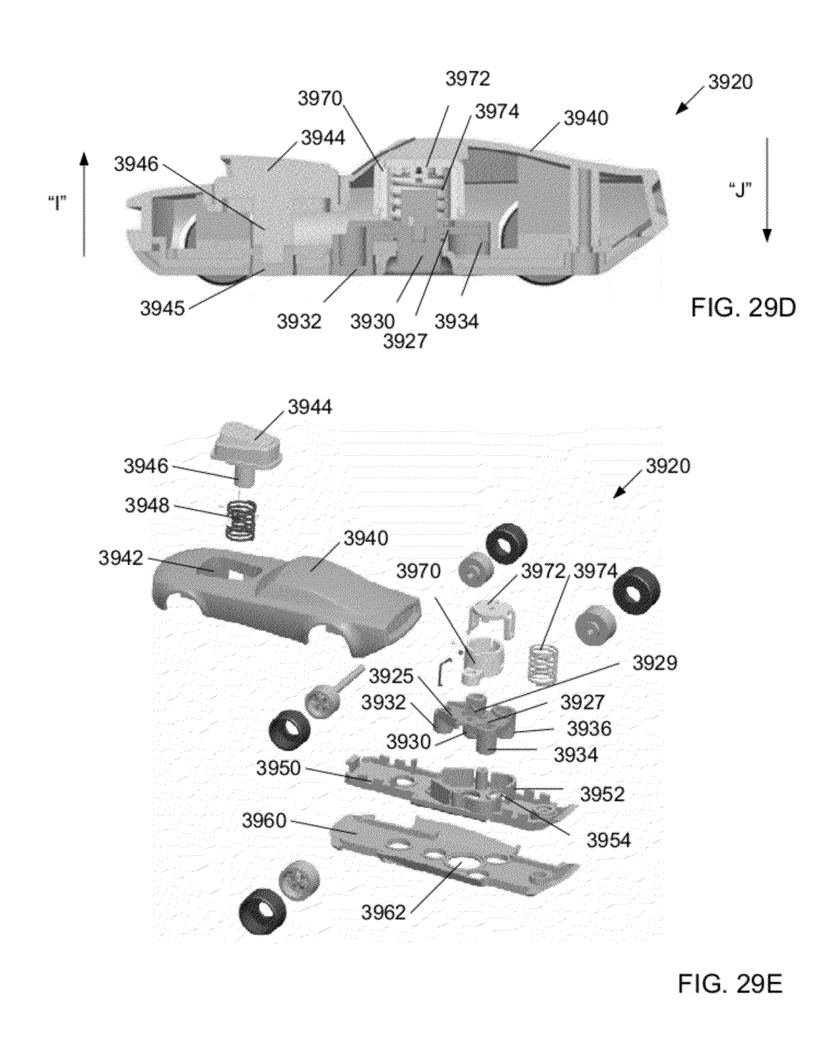

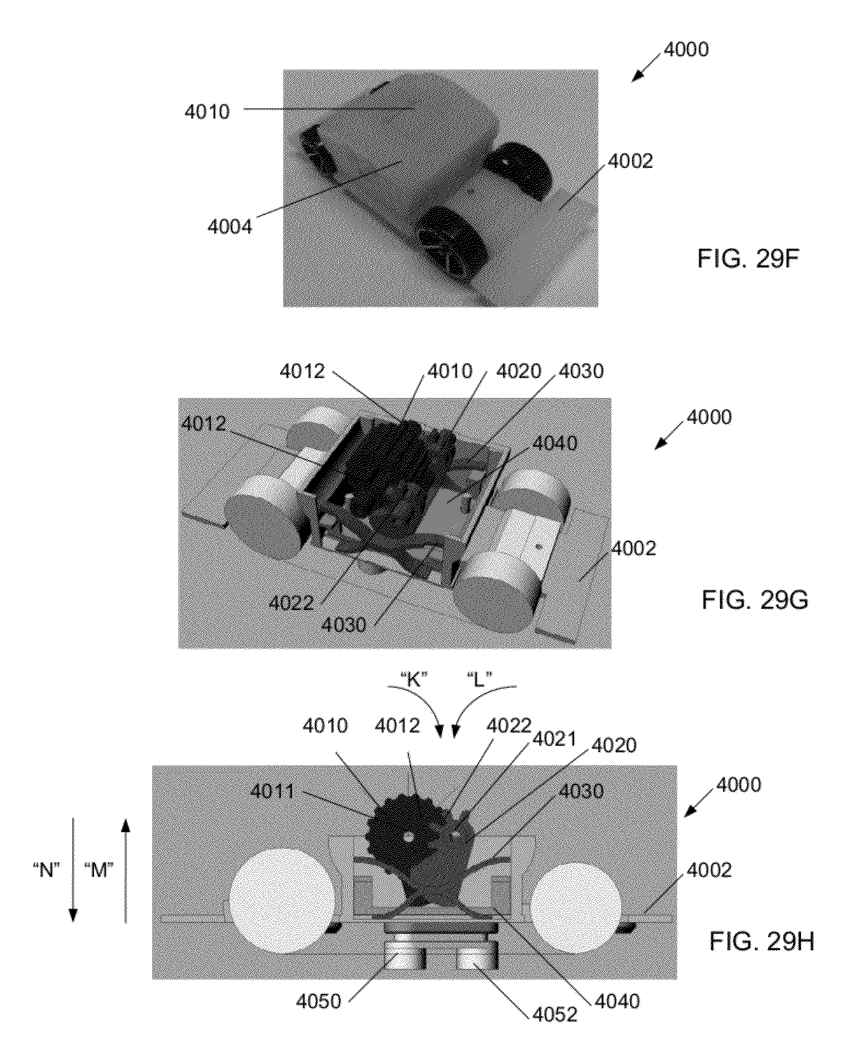

Referring to FIG. 29A, another embodiment of an input object is illustrated. In this embodiment, the input object is a toy vehicle 3900 that has a body 3902 with a lower surface 3904. The body 3902 has a hood portion that defines an opening in which an actuator 3908 is movably mounted. The actuator 3908 is biased upwardly by a biasing member, such as a spring, and can be pressed downwardly along the direction of arrow “H.” In different embodiments, the actuator 3908 can be located at different positions on the toy vehicle 3900. In another embodiment, the hood scoop is electrically isolated from the conductive body of the toy vehicle. The hood scoop is connected to a contact member that extends a fixed distance from the lower surface of the toy vehicle and is in continuous contact with the touch screen. As a result, the scoop functions as a separate touch button that is used to provide inputs.

A bottom perspective view of the toy vehicle 3900 is illustrated in FIG. 29B. As shown, the toy vehicle 3900 includes several wheels 3906 that are rotatably coupled to the body or chassis. In addition, the toy vehicle 3900 includes contact members 3912, 3914, and 3916 that extend downwardly from the lower surface 3904. The contact members 3912, 3914, and 3916 are conductive contact members and can be used with a capacitive screen to identify the toy vehicle 3900 based on the relative distances between the contact members 3912, 3914, and 3916 and the touch points that they create. In another embodiment, the wheels do not rotate relative to the body. The rear wheels are conductive contact members that can be used to form touch points.

In this embodiment, while contact members 3912, 3914, and 3916 are fixedly coupled to the toy vehicle 3900 and do not move relative thereto, toy vehicle 3900 has another contact member 3918 that is mounted for movement. Contact member 3918 can be retracted and extended relative to the lower surface 3904. When contact member 3918 extends from the lower surface 3904, each of the contact members 3912, 3914, 3916, and 3918 extends the same distance from the lower surface. Accordingly, the contact members 3912, 3914, 3916, and 3918 engage or are proximate to a screen on which the toy vehicle 3900 is placed or held close to. The position of contact member 3918 is controlled by the user via the actuator 3908 which is coupled to contact member 3918. When the actuator 3908 is pressed downwardly by the user, contact member 3918 extends downwardly from the toy vehicle 3900. When the actuator 3908 is released, contact member 3918 is retracted into the toy vehicle 3900 and does not contact the screen and thus, is not detected by the electronic device. Accordingly, the user has the ability to selectively extend contact member 3918 to provide periodic inputs to the touch screen as desired.

Another embodiment of an input device is illustrated in FIG. 29C. In this embodiment, the user has the option of retracting all of the contact members on the toy vehicle to facilitate play with the toy vehicle on any surface in a conventional manner. In other words, when all of the contact members are retracted, nothing extends from the lower surface of the toy vehicle. As illustrated, the toy vehicle 3920 has a body 3922 with a lower surface 3924 and several rotatably mounted wheels. Contact member 3938, shown in its retracted position, corresponds to contact member 3918 illustrated in FIG. 29B. An actuator (not shown in FIG. 29C) can be pressed by a user to overcome a biasing member and extend contact member 3938 from the lower surface 3924 as desired.

Contact members 3932, 3934, and 3936 are mounted in holes formed in the lower surface 3924 of the toy vehicle 3920. Each of the contact members 3932, 3934, and 3936 is illustrated in its retracted position in FIG. 29C. The contact members 3932, 3934, and 3936 are coupled together and move as a single unit. A positioner 3930 is movably mounted in a hole in the lower surface 3924 as well. The positioner 3930 can be pressed along the direction of arrow “I” to successively retract the contact members 3932, 3934, and 3936 and allow them to extend, as described below.

Referring to FIGS. 29D and 29E, the internal components of the toy vehicle 3920 are illustrated. The toy vehicle 3920 includes an upper body portion 3940 with an opening 3942 formed therein and a lower body portion 3960 with several openings 3962 formed therethrough. A lower plate 3950 is positioned adjacent to the lower body portion 3960. The lower plate 3950 has several upstanding wall members 3952 that define a region or area therebetween around openings 3954.

The toy vehicle 3920 includes a movable member 3925 that has a plate 3927 with contact members 3932, 3934, and 3936 and positioner 3930 extending therefrom. In this embodiment, the plate 3927, the contact members 3932, 3934, and 3936, and the positioner 3930 are integrally formed of a conductive material or formed of a non-conductive material that has a conductive coating thereon. The movable member 3925 is located in the area defined by the wall members 3952 with the contact members 3932, 3934, and 3936, and positioner 3930 aligned with the corresponding holes 3954 and 3962 in the lower plate 3950 and the lower body portion 3960. The movable member 3925 is mounted for movement along the directions of arrows “I” and “J” shown in FIG. 29D.

A catch or latching mechanism maintains the movable member 3925 in its retracted position. The catch includes a housing 3970 defining a sleeve with an opening and a latch 3972. A biasing member 3974, such as a spring, is located in the opening of the sleeve and is engaged with the movable member 3925. The movable member 3925 has a post 3929 on which the biasing member 3974 can be positioned. The biasing member 3974 provides a force on the movable member 3925 along the direction of arrow “J.”

When a user presses on positioner 3930 to move the movable member 3925 along the direction of arrow “I,” the housing 3970 and latch 3972 function to retain the movable member 3925 in its retracted position. As a result, the contact members 3932, 3934, and 3936 are in their retracted positions as well, thereby allowing the user to play with the toy vehicle 3920 in any desired manner without any obstructions along the lower surface of the vehicle 3920.

When the user desires to use the toy vehicle 3920 with a touch screen, the conductive contact members 3932, 3934, and 3936 can be selectively extended from the toy vehicle 3920. The user presses the positioner 3930 again to disengage and release the catch, thereby allowing the biasing member to bias the movable member 3925 along the direction of arrow “J.” Member 3925 moves in that direction until the plate 3927 engages the inner surface of the lower plate 3950, thereby stopping the movement of member 3925. In this position, the contact members 3932, 3934, and 3936 and the positioner 3930 extend outwardly from the lower surface of the toy vehicle. When the contact members 3932, 3934, and 3936 extend outwardly, each of them is positioned to create a touch point on a capacitive screen that can be detected. The positioner 3930 is shorter than the contact members 3932, 3934, and 3936 and accordingly, does not engage the touch screen to create a touch point. The identity of the toy vehicle 3920 can be determined based on the pattern of touch points created by contact members.

When the user desires to retract the contact members, the user can press on the positioner 3930 along the direction of arrow “I,” until the housing 3970 and the latch 3972 engage the movable member 3925 to retain the movable member 3925 in its retracted position (shown in FIG. 29D).

The toy vehicle 3920 also includes a selectively movable contact member 3945 that is illustrated in its retracted position in FIG. 29D. The contact member 3945 is mounted on a lower end of a shaft 3946 coupled to actuator body 3944. The contact member 3945 can be a piece of conductive material mounted on the shaft 3946 or a coating on the shaft 3946. The actuator body 3944 is mounted in opening 3942 from below and biased upwardly by biasing member 3948. The actuator body 3944 is prevented from moving out of the opening by a lip formed on the body 3944. The user can press on the body 3944 along the direction of arrow “J” against the biasing member 3948 to move contact member 3945 into contact or proximate to a capacitive touch screen to form a touch point. When the user releases the body 3944, the biasing member 3946 forces the body 3944 with contact member 3945 along the direction of arrow “I” to its retracted position. Thus, the ability of contact member 3945 to be selectively deployed allow a user to provide an input to a touch screen at particular desired times and locations.

Referring to FIGS. 29F-29H, another embodiment of an input object is illustrated. In this embodiment, the input object is a toy vehicle, of which some of the components are illustrated in FIG. 29F. The toy vehicle 4000 includes a lower body portion or chassis 4002 and an upper body portion 4004. The upper body portion 4004 has an opening through which an actuator 4010 is accessible. The actuator 4010 is rotatably mounted to the upper body portion 4004 about pivot axis 4011 (see FIG. 29H) and has an outer surface with grooves and ridges that can be engaged by a user to move the actuator 4010. As shown in FIG. 29G, the actuator 4010 also includes a pair of gear portions 4012 on opposite sides that have corresponding sets of gear teeth.

Also rotatably mounted to the upper body portion 4004 is a driven gear 4020 that rotates about pivot axis 4021. Driven gear 4020 has a pair of its own gear portions 4022 with gear teeth that mesh with the teeth on the actuator 4010. When a user rotates actuator 4010 about axis 4011 along the direction of arrow “K,” the meshing teeth of actuator 4010 and gear 4020 cause the gear 4020 to rotate about axis 4021 along the direction of arrow “L.” The toy vehicle 4000 also includes biasing members 4030 which are described in detail below.

The toy vehicle 4000 also includes a movable member 4040 that can slide up and down in the toy vehicle 4000. Coupled to the movable member 4040 are contact members 4050 and 4052. Additional contact members may be coupled to the movable member 4040. As the movable member 4040 is moved along the direction of arrow “M” to a retracted position, the contact members 4050 and 4052 are also retracted. As shown in FIG. 29G, the biasing members 4030 are engaged with the movable member 4040 and bias the movable member 4040 along arrow “M” to its retracted position.

The force of the biasing members 4030 is overcome when the user moves actuator 4010 along the direction of arrow “K.” The rotation of the actuator 4010 and the driven gear 4020 causes surfaces thereon to push the movable member 4040 along the direction of arrow “N” to extend the contact members 4050 and 4052 to positions that enable the contact members 4050 and 4052 to create touch points on a touch screen. When the user releases the actuator 4010, the biasing members 4030 move the movable member 4040 along the direction of arrow “M.” Thus, the actuator 4010 enables a user to selectively deploy or extend the contact members of the toy vehicle 4000 when desired.

In another embodiment, the object includes two or more contact members, as well as data stored in an associated memory. Upon depression of the object against the touch screen, the data is transmitted from the object to the electronic device. For example, a user's contact information may be transmitted to the electronic device upon depression or activation of the object. The object may be configured such that different or additional data is transmitted upon subsequent depressions or activations. For example, an address of the user may be transmitted upon an initial depression or engagement of the object against the touch screen of an electronic device. The user's business profile (e.g., employment history, technical skills, etc.) may then be transmitted from the object to the electronic device upon a subsequent depression or engagement between the object and the touch screen.

In another embodiment, the object, once properly identified by an application, may ‘unlock’ a database accessible to the electronic device, which may include information relating to the object. For example, collector dolls may be provided with contact members that can be used with an electronic device to identify the object. Upon engagement with the touch screen by the contact members, information relating to collector type data is presented to the user.

Thus, the recognized pattern of contact points may be used by an application running on the electronic device to identify the particular conductive object and/or to provide specific information related to the object or user. Various applications may be run on the electronic device that use the contact and identification of the conductive object as an input. For example, a game application can look for a particular object to be used with the screen at a particular point in the game. If the correct object is placed on the screen, then a feature or portion of the game can be unlocked and/or a particular output may be generated and displayed.

The electronic device and associated application are configured to generate an output specific to a recognized pattern of contact points on the touch screen, as well as in response to movement of the recognized pattern of contact points on the touch screen. The pattern of contact points defines an identification that is associated with a particular object. An output specific to the associated object is then generated and displayed on the touch screen. The particular output generated and displayed may vary depending on the various patterns of engagement points associated with the corresponding various objects, as well as on the particular application operable by the device.

In different implementations, the conductive devices or objects can be hard or soft. Further, the particular types and locations of touches or contact points on the touch screen can vary, as well as the content that is unlocked or accessed. Thus, various embodiments of the present invention are possible.

The quantity of contact points that can be detected by an application is determined in part by the particular electronic device running the application.

It is to be understood that terms such as “left,” “right,” “top,” “bottom,” “front,” “end,” “rear,” “side,” “height,” “length,” “width,” “upper,” “lower,” “interior,” “exterior,” “inner,” “outer” and the like as may be used herein, merely describe points or portions of reference and do not limit the present invention to any particular orientation or configuration. Further, terms such as “first,” “second,” “third,” etc., merely identify one of a number of portions, components and/or points of reference as disclosed herein, and do not limit the present invention to any particular configuration or orientation.

Although the disclosed inventions are illustrated and described herein as embodied in one or more specific examples, it is nevertheless not intended to be limited to the details shown, since various modifications and structural changes may be made therein without departing from the scope of the inventions. In addition, various features from one of the embodiments may be incorporated into another of the embodiments. Accordingly, it is appropriate that the invention be construed broadly and in a manner consistent with the scope of the disclosure.

What is claimed is:

1. A set of objects for use with an electronic device including a touch screen, the set system comprising:
a first object including a conductive portion and having a first contact member engageable with the touch screen and a second contact member engageable with the touch screen, the first contact member spaced from the second contact member by a first distance, the electronic device identifying the first object when the first and second contact members engage the touch screen to form first and second contact points, and the electronic device generates a visual output on the touch screen based on the location and the movement of the contact points; and
a second object including a conductive portion and having a third contact member engageable with the touch screen and a fourth contact member engageable with the touch screen, the third contact member spaced from the fourth contact member by a second distance, the second distance differing from the first distance, wherein the electronic device identifies the second object when the third and fourth contact members engage the touch screen to form third and fourth contact points.

2. The set of claim 1, wherein the electronic device identifies the first object based on the first distance between the first and second contact points and identifies the second object based on the second distance between the third and fourth contact points.

3. The set of claim 1, wherein each of the first object and the second object is one of a toy figure or a toy vehicle.

4. The set of claim 1, wherein the first object includes a third contact member, the third contact member creating a third contact point when the first object is proximate to the touch screen, the third contact member being spaced from a line connecting the first and second contact members by a third distance, the first distance being used by the electronic device to determine a category of the first object and the third distance being used by the electronic device to determine the identity of the first object within the category.

5. The set of claim 1, wherein the first object includes a third contact member and a fourth contact member, each of the contact members being engageable with the touch screen to create a contact point detectable by the electronic device, the fourth contact member being located within the perimeter of the shape defined by the first, second, and third contact members, the electronic device is configured to use the first, second, and third contact members to identify a grid relating to the position of the object on the touch screen, and the electronic device is configured to use the location of the fourth contact member on the grid to identify the first object.

6. An object for use with an electronic device including a touch screen, the object comprising:
a housing with a conductive portion;
a first contact member engageable with the touch screen and coupled to the housing;
a second contact member engageable with the touch screen and coupled to the housing;
a third contact member coupled to the housing, the third contact member being conductively isolated from the first contact member and the second contact member, the first contact member spaced from the second contact member by a first distance, wherein the electronic device identifies the object when the first and second contact members engage the touch screen to form first and second contact points, and the electronic device generates a visual output on the touch screen based on the location and the movement of the contact points.

7. The object of claim 6, wherein the third contact member is movably mounted on the housing so that the third contact member can be moved into and out of engagement with the touch screen.

8. The object of claim 7, further comprising:
an actuator coupled to the third contact member, the actuator being movable relative to the housing so that movement of the actuator results in movement of the third contact member relative to the housing.

9. The object of claim 6, further comprising:
a biasing mechanism biasing the third contact member away from the touch screen when the object is proximate to the touch screen.

10. The object of claim 6, wherein the object is a toy vehicle with a chassis and the third contact member moves relative to the chassis.

11. The object of claim 10, wherein the third contact member extends from a lower surface of the chassis when the third contact member is moved by a user.

12. The object of claim 11, further comprising:
an actuator coupled to the third contact member, the actuator being movable relative to the housing so that movement of the actuator results in movement of the third contact member, and the actuator extends upwardly from the toy vehicle.

13. The object of claim 6, wherein the first contact member and the second contact member are selectively positionable relative to the object.

14. The object of claim 13, wherein the first contact member and the second contact member are placeable in retracted positions and in extended positions relative to the housing.

15. The object of claim 14, further comprising:
a biasing mechanism that biases at least one of the first contact member or the second contact member to its extended position.

16. The object of claim 15, further comprising;
a catch configured to retain at least one of the first contact member or the second contact member in its retracted position against the force of the biasing mechanism.

17. A method of using a conductive object with a touch screen of an electronic device, the conductive object including a housing, a first contact member coupled to the housing, a second contact member coupled to the housing, and a third contact member movably mounted to the housing, the method comprising the steps of:
determining a pattern of engagement points on the touch screen when the conductive object is proximate to the touch screen, the engagement points being formed by the first contact member, the second contact member, and the third contact member when the conductive object is proximate to the touch screen and the third contact member is selectively moved relative to the housing into engagement with the touch screen;
determining information about the conductive object based on the engagement points; and
generating an output based on the information determined about the conductive object.

18. The method of claim 17, wherein the first contact member is spaced from the second contact member by a first distance, the third contact member is spaced from a line connecting the first and second contact members by a second distance, and the first distance and the second distance are used by the electronic device to identify the conductive object.

19. The method of claim 17, wherein the step of generating an output includes generating feedback on the touch screen based on movement of the engagement points.

20. The method of claim 19, wherein the feedback on the touch screen includes at least one of an image associated with the conductive object or additional content in an application running on the device.
